(19) United States
(12) Patent Application Publication
(10) Pub. No.: US 2005/0088597 A1
(43) Pub. Date: Apr. 28, 2005

(54) Liquid crystal display device and electronic apparatus

(75) Inventors: Tsuyoshi Maeda, Kai (JP); Hayato Kurasawa, Matsumoto (JP); Joji Nishimura, Matsumoto (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/943,206

(22) Filed: Sep. 17, 2004

(30) Foreign Application Priority Data
Oct. 2, 2003 (JP) 2003-344446

(51) Int. Cl. G02F 1/1343

(52) U.S. Cl. 349/139

(57) ABSTRACT

To provide a transflective liquid crystal display device in a vertical alignment mode that is capable of displaying bright and high-contrast images in a wide viewing angle range, a liquid crystal layer is interposed between a pair of substrates opposite to each other, and display is performed in a predetermined pixel unit. The liquid crystal layer is composed of liquid crystal having a vertical alignment in an initial state, specifically, having negative dielectric anisotropy. Signal lines through which signals are supplied to the pixels, are formed on the inner surface of either of the pair of substrates. Convex portions made of a dielectric material are formed around and/or on the signal lines on the inner surface of either of the pair of substrates.

### BACKGROUND OF THE INVENTION

1. Field of Invention

Exemplary aspects of the present invention relate to a liquid crystal display device and an electronic apparatus, and more particularly, to a liquid crystal display device that is capable of displaying high-contrast images in a wide viewing angle range using vertical alignment type liquid crystal molecules.

2. Description of Related Art

A related art transflective liquid crystal display device having both a reflective display mode and a transmissive display mode can be used as a liquid crystal display device. A related art liquid crystal display device has been disclosed to include a transflective liquid crystal display device in which a liquid crystal layer is interposed between an upper substrate and a lower substrate. An inner surface of the lower substrate is provided with a reflective film composed of a metal film, such as aluminum film, having an opening for transmitting light therein. The reflective film functions as a transflective film. In this case, in the reflective mode, external light incident on the upper substrate passes through the liquid crystal layer. The light is then reflected from the reflective film on the inner surface of the lower substrate. Then, the light passes through the liquid crystal layer again and exits from the upper substrate to display an image. In a transmissive mode, the light incident on the lower substrate from a backlight passes through the opening formed in the reflective film into the liquid crystal layer. The light then exits from the upper substrate to the outside to display an image. In the reflective film, a region in which the opening is formed is a transmissive display region, and the other region is a reflective display region.

However, the related art transflective liquid crystal display device has a problem in that a viewing angle is narrow in a transmissive display mode. In addition, since a transflective plate is provided on the inner surfaces of liquid crystal cells in order to prevent the generation of parallax, display must be performed using only one polarizing plate provided on the viewer side, resulting in a reduction in the degree of freedom on an optical design. Therefore, in order to address and/or solve the above-mentioned and/or other problems, the inventors, M. Jisaki et al., have proposed a liquid crystal display device using vertical alignment type liquid crystal in Japanese Unexamined Patent Application Publication No. 11-242226. The disclosed liquid crystal display device has the following three features:
(1) The liquid crystal display device has a “VA (Vertical Alignment) mode” in which liquid crystal having negative dielectric anisotropy is vertically aligned on a substrate, and is then inclined by the application of a voltage;
(2) The liquid crystal display device has a “multi gap structure” in which the thickness (the cell gap) of a liquid crystal layer in a transmissive display region is different from the thickness of the liquid crystal layer in a reflective display region; and
(3) The liquid crystal display device has an “alignment dividing structure” in which each transmissive display region is formed in the shape of a regular octagon, and a projection is formed at the center of each transmissive display region on a counter substrate to make liquid crystal molecules incline in all directions.

### SUMMARY OF THE INVENTION

In “Development of transflective LCD for high contrast and wide viewing angle by using homeotropic alignment”, M. Jisaki et al., Asia Display/IDW'01, p. 133 to 136 (2001), the alignment directions of liquid crystal molecules are controlled by the projection formed at the center of the transmissive display region. However, “Development of transflective LCD for high contrast and wide viewing angle by using homeotropic alignment”, M. Jisaki et al., Asia Display/IDW'01, p. 133 to 136 (2001) does not disclose regulating the alignment of the liquid crystal molecules in regions other than the transmissive display region. Particularly, it is not at all disclosed to control the alignment of the liquid crystal molecules in the vicinities of signal lines, such as data lines and scanning lines, through which signals are transmitted to pixels.

Accordingly, exemplary aspects of the present invention address and/or solve the above-mentioned and/or other problems. Exemplary aspects of the present invention provide a transflective liquid crystal display device in a vertical alignment mode that is capable of appropriately regulating the alignment of liquid crystal molecules in the vicinities of signal lines through which signals are supplied to pixels, thereby reducing or preventing the generation of display defects, such as a residual image and color unevenness, and displaying an image in a wide viewing angle range.

In order to achieve the above exemplary aspects of the present invention provide a liquid crystal display device in which a liquid crystal layer is interposed between a pair of substrates, and display is performed in predetermined pixel units. The liquid crystal layer is composed of liquid crystal having negative dielectric anisotropy that is vertically aligned in an initial state, and signal lines through which signals are supplied to the pixels are formed on an inner surface of at least one of the pair of substrates. Convex portions made of a dielectric material are formed around and/or on the signal lines on the inner surface of the at least one of the pair of substrates.

Exemplary aspects of the present invention provide a method to appropriately regulate the alignment directions of liquid crystal molecules according to the application of a voltage in a vertical alignment type liquid crystal display device. Specifically, in a liquid crystal display device equipped with a liquid crystal layer composed of liquid crystal having negative dielectric anisotropy that is vertically aligned in an initial state. Since a horizontal electric field is generated between electrodes formed in pixels and signal lines through which signals are supplied to the pixels, liquid crystal may be aligned differently from a normal alignment by an electric field commonly generated between electrodes under the influence of the horizontal electric field. Therefore, exemplary aspects of the present invention prevent or suppress such a problem, thereby enhancing display characteristics.

Specifically, the above-mentioned problem is addressed and/or solved by forming convex portions (device to give convex shapes on a substrate facing to a liquid crystal layer) made of a dielectric material around and/or on the signal lines on the substrate as described above. For example, when the convex portions are formed around and/or on the signal lines on the substrate, the convex portions are formed so as to isolate the signal lines from the electrodes. Therefore, it is possible to prevent or suppress the generation of an electric field (a horizontal electric field) between the signal lines and the electrodes. Even when the horizontal electric field is generated, it is possible to align liquid crystal molecules in a predetermined direction by the alignment regulating force generated due to the shape of the convex portion without being influenced by the horizontal electric field. Specifically, by the alignment regulating force that has a larger influence on the liquid crystal molecules than the horizontal electric field. As a result, it is possible to control or regulate the alignment directions of the liquid crystal molecules in regions around the signal lines, and thus to reduce or prevent the generation of a display defect, such as light leakage generated due to the alignment disorder (disclination) of the liquid crystal molecules, thereby suppressing the generation of display defects, such as a residual image and color unevenness. Accordingly, it is possible to a liquid crystal display device having a wide viewing angle.

Further, for example, when the convex portions are formed so as to cover the signal lines in plan view on the other substrate, other than the substrate having the signal lines thereon, there is no effect of suppressing the electric field between the signal lines and the electrodes. Therefore, it is possible to align, in a predetermined direction, the liquid crystal molecules in the vicinities of the regions in which the signal lines are formed, by the alignment regulating force generated due to the shape of the convex portion without being influenced by the horizontal electric field. Specifically, by the alignment regulating force that has a larger influence on the liquid crystal molecules than the horizontal electric field.

In order to address and/or solve the above-mentioned and/or other problems, exemplary aspects of the present invention provide a liquid crystal display device in which a liquid crystal layer is interposed between a pair of substrates, and display is performed in predetermined pixel units. The liquid crystal layer is composed of liquid crystal having negative dielectric anisotropy that is vertically aligned in an initial state, and signal lines through which signals are supplied to the pixels are formed on an inner surface of at least one of the pair of substrates. Convex portions, made of a dielectric material, are formed on the inner surface of the at least one of the pair of substrates so as to cover at least the signal lines in plan view.

As described above, it is also possible to address and/or solve the above-mentioned and/or other problems by forming the convex portions made of a dielectric material so as to cover the signal lines formed on the substrate in plan view. For example, when the convex portions are formed on the substrate having the signal lines thereon so as to directly cover the signal lines, the convex portions are formed to isolate the signal lines from the electrodes. Therefore, it is possible to prevent or suppress the generation of the electric field (the horizontal electric field) between the signal lines and the electrodes. Even when the horizontal electric field is generated, it is possible to align, in a predetermined direction, the liquid crystal molecules in the vicinities of the regions where the signal lines are formed, by the alignment regulating force generated due to the shape of the convex portion without being influenced by the horizontal electric field. Specifically, by the alignment regulating force that has a larger influence on the liquid crystal molecules than the horizontal electric field.

Furthermore, for example, when the convex portions are formed so as to cover the signal lines in plan view on the other substrate, other than the substrate having the signal lines thereon, there is no effect of suppressing the electric field between the signal lines and the electrodes. Therefore, it is possible to align, in a predetermined direction, the liquid crystal molecules in the vicinities of the regions in which the signal lines are formed, by the alignment regulating force generated due to the shape of the convex portion without being influenced by the horizontal electric field, that is, by the alignment regulating force that has a larger influence on the liquid crystal molecules than the horizontal electric field.

The convex portions used in the liquid crystal display device of an exemplary aspect of the present invention can have a structure to regulate the alignment directions of the vertically aligned liquid crystal molecules, according to a change of an electric field (an electric field between electrodes). Specifically, the convex portion protruding from the inner surface of the substrate toward the liquid crystal layer may be composed of a cone-shaped or polygonal pyramid-shaped projection having an incline plane that is inclined at a predetermined angle with respect to the surface of the substrate. In addition, the surface (the incline plane) of the convex portion may be formed so as to be inclined at a predetermined angle with respect to the alignment directions of the liquid crystal molecules. The incline plane of the convex portion may have a maximum inclination angle of 2° to 20°. In this case, the inclination angle is an angle formed between the incline plane of the convex portion and the substrate. When the convex portion has a curved surface, the inclination angle indicates an angle formed between the surface of the substrate and a surface tangent to the curved surface of the convex portion. In this case, when the maximum inclination angle is less than 2°, it may be difficult to regulate the directions in which the liquid crystal molecules are inclined. When the maximum inclination angle is more than 20°, light leakage may be generated from those portions, resulting in a display defect, such as the deterioration of contrast.

Moreover, the convex portions, which each have a longitudinal shape, may extend along each of the signal lines, and the convex portions, which each have a dot shape, may extend along each of the signal lines. In both cases, it is possible to appropriately regulate the inclined directions of the liquid crystal molecules based on the shape of the convex portion when a voltage is applied. When pixel electrodes are formed on the inner surface of the substrate on which the signal lines are formed, at least a portion of each convex portion may be formed between the pixel electrodes and the signal lines. Further, each convex portion may be formed so as to be laid across the pixel electrodes and the signal lines in plan view. Each convex portion may be formed so as to be laid across the edge of the pixel electrodes and the signal lines in plan view. Furthermore, each convex portion may be formed so as to cover both a portion of the pixel electrode and the signal line. In all cases, it is possible to obtain the same effects as described above. In addition, a plurality of the convex portions may be formed in each pixel.

The pixel electrodes are formed on the inner surface of the substrate on which the signal lines are formed, and each convex portion is formed at positions in where the pixel electrodes are closest to the signal lines. In this case, the convex portion can be formed at the positions where the pixel electrodes are closest to the signal lines so as to isolate the electrodes from the signal lines. Therefore, it is possible to more effectively prevent or suppress the generation of the horizontal electric field between the electrode and the signal line. Even when the horizontal electric field is generated therebetween, it is possible to appropriately regulate the alignment of the liquid crystal molecules based on the shape of the convex portion.

Further, the convex portions may be formed on the substrate on which the scanning lines are formed. The convex portions may be formed on the other substrate, other than the substrate on which the scanning lines are formed. Particularly, when the convex portions are formed on the substrate having the scanning lines thereon, it is possible to more effectively prevent or suppress the generation of the horizontal electric field between the signal line and the electrode, and to appropriately generate the alignment regulating force due to the shape of the convex portion.

Furthermore, a light-shielding film may be formed so as to overlap with the convex portions in plan view. When the convex portions are formed as described in the exemplary aspect of the present invention, the liquid crystal molecules that are vertically aligned on the convex portions, particularly, on the incline planes of the convex portions are not vertically aligned with respect to the surface of the substrate. In this case, light leakage may occur. Therefore, by forming the light-shielding film so as to overlap with the convex portions in plan view as described above, it is possible to prevent or suppress the generation of the light leakage, and thus to provide a liquid crystal display device having excellent display characteristics, such as high contrast and the like. The light-shielding film can be formed on the same substrate as the convex portions are formed, or on another substrate other than the substrate having the convex portions thereon. In addition, it is possible to make the convex portions function as a light-shielding film by dispersing a light-shielding pigment in each convex portion.

Furthermore, in the liquid crystal display device of an exemplary aspect of the present invention, spacers to define the gap between the pair of substrates are formed on the inner surface of the at least one of the pair of substrates, and the convex portions are made of the same material as the spacers. In this case, it is possible to form the spacers (the scallop-shaped spacers) and the convex portions on the substrate in the same process, resulting in a simple manufacturing process and a reduction in manufacturing costs. Insulating films, each having a predetermined pattern, are formed on the inner surfaces of the pair of substrates. Out of the patterns of the insulating films, one pattern functions as the spacers to define the thickness of the liquid crystal layer by forming so as to come into contact with the opposite substrate, and the other pattern functions as the convex portions protruding from the inner surface of the substrate toward the liquid crystal layer. Thus, it is possible to reduce manufacturing costs.

Next, the liquid crystal display device of an exemplary aspect of the present invention may be a transmissive or reflective liquid crystal display device. Herein, the pair of substrates is an upper substrate and a lower substrate. The above-mentioned convex portions may be formed in a transmissive liquid crystal display device in which a backlight is formed on a surface of the lower substrate opposite to the liquid crystal layer to display an image on an outer surface of the upper substrate. On the other side, the convex portions may be formed in a reflective liquid crystal display device in which a reflective layer is provided on a surface of the lower substrate facing the liquid crystal layer.

Furthermore, it is possible to apply the structure of an exemplary aspect of the present invention to a transflective liquid crystal display device. That is, the structure of an exemplary aspect of the present invention can be applied to a liquid crystal display device in which a transmissive display region for transmissive display and a reflective display region for reflective display are provided in each dot. Specifically, the structure an exemplary aspect of the present invention can be applied to a liquid crystal display device in which the pair of substrates is an upper substrate and a lower substrate. A backlight is provided on a substrate of the lower substrate opposite to the liquid crystal layer. A reflective layer is selectively provided on only a predetermined region on the other surface of the lower substrate facing the liquid crystal layer. A region in which the reflective layer is formed is a reflective display region. A region in which the reflective layer is not formed is a transmissive display region.

Moreover, in the transflective liquid crystal display device, a layer to adjust the thickness of the liquid crystal layer is formed in the reflective display region between the liquid crystal layer and the at least one of the pair of substrates such that the thickness of the liquid crystal layer in the reflective display region is different from the thickness of the liquid crystal layer in the transmissive display region. By selectively forming the layer to adjust the thickness of the liquid crystal layer in the reflective display region, it is possible to make retardation in the reflective display region substantially equal to retardation in the transmissive display region, thereby enhancing contrast.

Further, in the transflective liquid crystal display device having the layer to adjust the thickness of the liquid crystal layer, the convex portions can be selectively formed in the transmissive display region. In the liquid crystal display device having the layer to adjust the thickness of the liquid crystal layer, since the thickness of the liquid crystal layer in the reflective display region is smaller than the thickness of the liquid crystal layer in the transmissive display region, the electric field between the electrodes is stronger in the reflective display region than in the transmissive display region. Thus the liquid crystal molecules in the reflective display region are less influenced by the horizontal electric field. Since the electric filed between the electrodes is weaker in the transmissive display region than in the reflective display region, the liquid crystal molecules in the transmissive display region are much influenced by the horizontal electric field. Therefore, it is possible to prevent or suppress the influence of the horizontal electric field on the liquid crystal molecules in the transmissive display region by forming the convex portions in the transmissive display region as described above.

Furthermore, the convex portions are selectively formed in the region in which the reflective layer is formed (in the transmissive display region), and the convex portions define the gap between the pair of substrates. Since the liquid crystal layer in the reflective display region has a relatively small thickness due to the layer to adjust the thickness of the liquid crystal layer, the convex portions formed in the reflective display region can be used to define the gap (the thickness of liquid crystal cells) between the substrates, that is, as spacers. In this case, since the convex portions function to both regulate the alignment of liquid crystal and to define the gap between substrates, it is possible to simplify the structure of a liquid crystal display device and to decrease the number of manufacturing processes.

The convex portions may be formed in the transmissive display region each have a height of 0.05 μm to 1.5 μm. When the height of the convex portions is less than 0.05 μm, it is difficult to regulate the alignment directions of the liquid crystal molecules. When the height of the convex portions is more than 1.5 μm, the difference in retardation between a vertex portion and a bottom portion of the convex portion in the liquid crystal layer between becomes large, resulting in the deterioration of display characteristics.

Moreover, on the inner surface of the substrate on which the convex portions are formed, an opening is formed in each electrode at a position on the convex portion. In this case, since the electrode does not exist on the convex portion, the inclined direction of liquid crystal due to the shape of the convex portion is opposite to the direction of the electric lines of force. Therefore, the inclined direction of liquid crystal can be easily determined, and thus it is possible to more stably regulate the alignment of liquid crystal molecules.

Next, an electronic apparatus according to an exemplary aspect of the present invention includes the above-mentioned liquid crystal display device. Thus, according to an exemplary aspect of the present invention, it is possible to provide an electronic apparatus equipped with a display unit having a wide viewing angle and excellent display characteristics.

### BRIEF DESCRIPTION OF THE DRAWINGS

FIG. 1 is a schematic of a liquid crystal display device according to a first exemplary embodiment of the present invention;

FIG. 2 is a schematic illustrating the electrode structure of the liquid crystal display device according to the first exemplary embodiment of the present invention;

FIGS. 3(a) and 3(b) are schematics illustrating the main part of the liquid crystal display device according to the first exemplary embodiment of the present invention;

FIGS. 4(a) and 4(b) are schematics illustrating the main part of a liquid crystal display device according to a second exemplary embodiment of the present invention;

FIGS. 5(a) and 5(b) are schematics illustrating the main part of a liquid crystal display device according to a third exemplary embodiment of the present invention;

FIGS. 6(a) and 6(b) are schematics illustrating the main part of a liquid crystal display device according to a fourth exemplary embodiment of the present invention;

FIGS. 7(a) and 7(b) are schematics illustrating the main part of a liquid crystal display device according to a fifth exemplary embodiment of the present invention;

FIG. 8 is a schematic of a part of the liquid crystal display device according to the first exemplary embodiment;

FIG. 9 is a schematic illustrating a modification of the main part shown in FIG. 8;

FIG. 10 is schematic of a main part of the liquid crystal display device according to the second exemplary embodiment;

FIG. 11 is a schematic illustrating a modification of the main part shown in FIG. 10;

FIGS. 12(a) and 12(b) are schematics illustrating the main part of a liquid crystal display device according to a sixth exemplary embodiment of the present invention;

FIGS. 13(a) and 13(b) are schematics illustrating the main part of a liquid crystal display device according to a seventh exemplary embodiment of the present invention;

FIGS. 14(a) and 14(b) are schematics illustrating the main part of a liquid crystal display device according to an eighth exemplary embodiment of the present invention;

FIGS. 15(a) and 15(b) are schematics illustrating a modification of the liquid crystal display device shown in FIG. 14;

FIG. 16 is a schematic illustrating the circuit structure of a liquid crystal display device according to a ninth exemplary embodiment of the present invention;

FIG. 17 is a schematic illustrating the main part of the liquid crystal display device shown in FIG. 16;

FIG. 18 is a schematic illustrating the main part of a modification of the liquid crystal display device shown in FIG. 16;

FIG. 19 is a schematic illustrating the main part of another modification of the liquid crystal display device shown in FIG. 16;

FIG. 20 is a schematic illustrating the main part of still another modification of the liquid crystal display device shown in FIG. 16; and

FIG. 21 is a schematic illustrating an example of an electronic apparatus according to an exemplary aspect of the present invention.

### DETAILED DESCRIPTION OF EXEMPLARY EMBODIMENTS

First Exemplary Embodiment

Hereinafter, exemplary embodiments of the present invention will be described with reference to the accompanying drawings. In the respective drawings, the reduced scale of each layer or each member is different from the actual scale because each layer or each member is scaled to be recognizable in the drawings.

A liquid crystal display device of the present exemplary embodiment, which will be described below, is an active matrix liquid crystal display device in which thin film diodes (hereinafter, referred to as “TFDS”) are used as switching elements, and is particularly a transmissive liquid crystal display device capable of performing display using light emitted from a backlight.

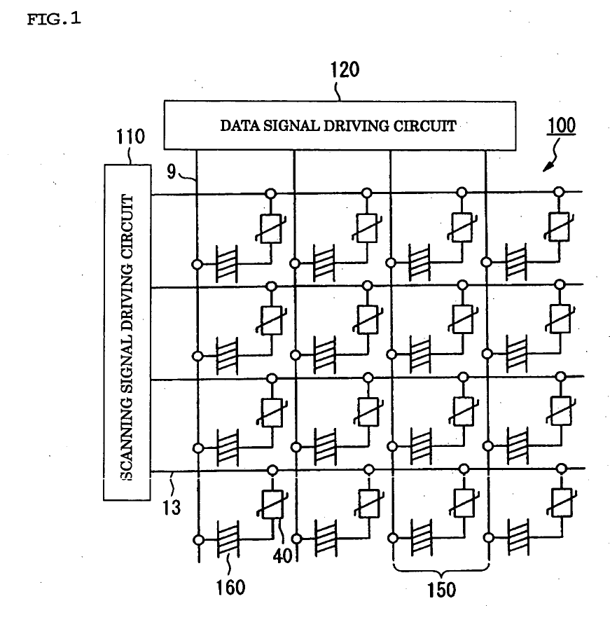

FIG. 1 is a schematic of a liquid crystal display device 100 according to the present embodiment. The liquid crystal display device 100 includes a scanning signal driving circuit 110 and a data signal driving circuit 120. The liquid crystal display device 100 is provided with signal lines, specifically, a plurality of scanning lines 13 and a plurality of data lines 9 intersecting with the plurality of scanning lines 13. The scanning lines 13 are driven by the scanning signal driving circuit 110, and the data lines 9 are driven by the data signal driving circuit 120. In each pixel region 150, a TFD element 40 is connected in series to a liquid crystal display element 160 (a liquid crystal layer) between the scanning line 13 and the data line 9. In FIG. 1, the TFD element 40 is connected to the scanning line 13, and the liquid crystal display element 160 is connected to the data line 9. The TFD element 40 may be connected to the data line 9, and the liquid crystal display element 160 may be connected to the scanning line 13.

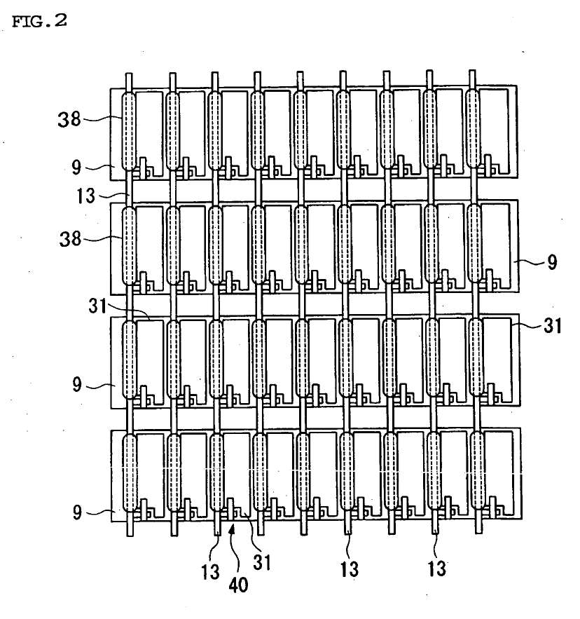

Next, the plane structure of electrodes (the structure of pixels) included in the liquid crystal display device 100 according to the present exemplary embodiment will be described with reference to FIG. 2. As shown in FIG. 2, in the liquid crystal display device 100, pixel electrodes 31, each of which has a rectangular shape in plan view and is connected to the scanning line 13 through the TFD element 40, are provided in a matrix. Rectangular common electrodes (stripe electrodes) 9 are provided so as to be opposite to the pixel electrodes 31 in a direction perpendicular to the paper in plan view. The common electrode 9 is composed of a data line and has a stripe shape intersecting with the scanning line 13. In the present exemplary embodiment, each region in which a pixel electrode 31 is formed is a dot region. A TFD element 40 is provided in each of the dot regions arranged in a matrix, thereby enabling each dot region to perform display.

The TFD element 40 is a switching element for connecting the scanning line 13 to the pixel electrode 31, and has an MIM structure in which a first conductive film, whose main ingredient is Ta, is formed, an insulating film, whose main ingredient is Ta₂O₃, is formed on the surface of the first conductive film, and a second conductive film whose main ingredient is Cr is formed on the surface of the insulating film. The first conductive film of the TFD element 40 is connected to the scanning line 13, and the second conductive film thereof is connected to the pixel electrode 31.

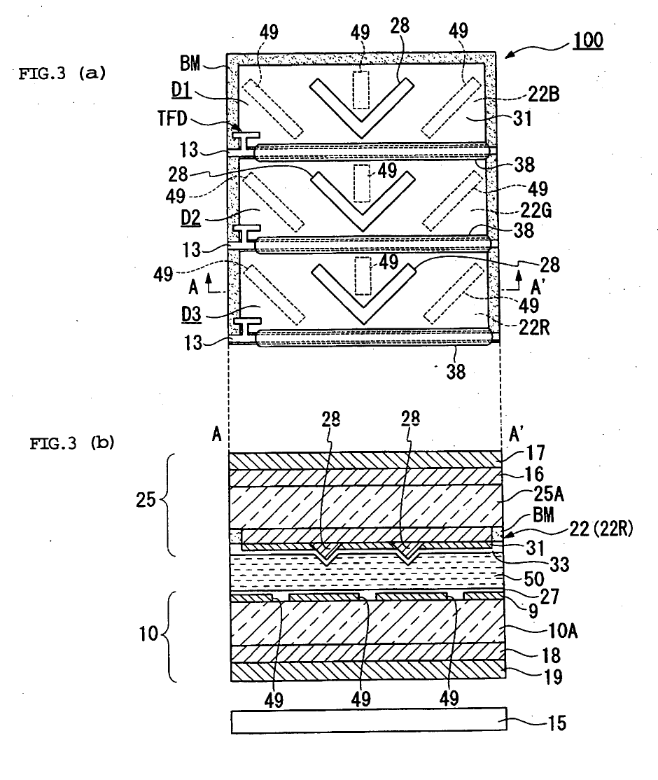

The pixel structure of the liquid crystal display device 100 according to the present embodiment will now be described with reference to FIG. 3. FIG. 3(a) is a schematic showing the pixel structure of the liquid crystal display device 100, and specifically showing the plane structure of the pixel electrode 31. FIG. 3(b) is a schematic cross-sectional view taken along the plane A-A′ of FIG. 3(a). The liquid crystal display device 100 of the present exemplary embodiment has dot regions (D1, D2, and D3) each having the pixel electrode 31. As shown in FIG. 3(a), one of the colored layers having the three primary colors is provided in each dot region so as to correspond to the colored layer. Pixels having colored layers 22B (blue), 22G (green), and 22R (red) are formed in the three dot regions (D1, D2, and D3), respectively, thereby enabling each pixel to perform display.

As shown in FIG. 3(b), in the liquid crystal display device 100 of the present exemplary embodiment, a liquid crystal layer 50 composed of liquid crystal having a vertical alignment in an initial state, specifically, liquid crystal having negative dielectric anisotropy, is interposed between an upper substrate (an element substrate) 25 and a lower substrate (a counter substrate) 10 opposite to the upper substrate 25. The liquid crystal display device 100 of the present exemplary embodiment is a transmissive liquid crystal display device adopting a vertical alignment mode.

The lower substrate 10 is composed of a substrate body 10A made of a transmissive material, such as quartz or glass. The stripe-shaped common electrodes 9 made of indium tin oxide (hereinafter, “ITO”) are formed on the surface of the substrate body 10A, and an alignment film 27 made of polyimide is formed on the common electrodes 9. The alignment film 27 functions as a vertical alignment film that allows liquid crystal molecules to be vertically aligned, and is not subjected to an alignment process, such as a rubbing process. In FIG. 3(b), the common electrodes 9 are formed in a stripe shape extending in a direction perpendicular to the paper, and are common to the respective dot regions formed in parallel to the direction perpendicular to the paper. Although a detailed description is omitted, the common electrode 9 has a slit 49 formed by cutting off a portion of the common electrode itself in a rectangular shape.

Next, in the upper substrate 25, color filters 22 (only a red colored layer 22R is shown in FIG. 3(b)) are formed on the substrate body 25A made of a transmissive material, such as glass or quartz. The edge of the red colored layer 22R is surrounded with a black matrix BM made of a metallic material, such as chrome, and the black matrix BM defines the boundaries of the respective dot regions D1, D2, and D3 (see FIG. 3(a)). In addition, matrix-shaped pixel electrodes 31 made of a transparent conductive material, such as ITO, and an alignment film 33 subjected to the same vertical alignment process as the lower substrate 10 made of polyimide are formed on the color filter 22. Although a detailed description is omitted, projections 28 protruding from the liquid crystal layer 50 are formed in rectangular shapes in plan view on the inner surface of the upper substrate 25.

A retardation plate 18 and a polarizing plate 19 are sequentially formed on the outer surface of the lower substrate 10 (on a surface different from the surface facing to the liquid crystal layer 50), and a retardation plate 16 and a polarizing plate 17 are sequentially formed on the outer surface of the upper substrate 25. Therefore, circularly polarized light can be incident on the inner surface of the substrate. A combination of the retardation plate 18 and the polarizing plate 19, and a combination of the retardation plate 16 and the polarizing plate 17 constitute circularly polarizing plates, respectively. The polarizing plate 17 (19) transmits only the linearly polarized light components each having a polarizing axis in a predetermined direction, and a λ/4 retardation plate is employed as the retardation plate 16 (18). A combination (a broadband circular polarizer) of a λ/2 retardation plate and a λ/4 retardation plate can also be used as the circularly polarizing plate. In this case, it is possible to perform black display rich in an achromatic color. In addition, it is possible to use a structure in which the polarizing plate, the λ/2 retardation plate, the λ/4 retardation plate, and a plate (a retardation plate having an optical axis in the thickness direction thereof) are combined to widen a viewing angle. A backlight 15, which is a light source for transmissive display, is provided on the outer side of the polarizing plate 19 formed on the lower substrate 10.

The liquid crystal display device 100 is a liquid crystal display device in a vertical alignment mode in which the above-mentioned liquid crystal layer 50 is made of a liquid crystal material whose dielectric anisotropy is negative. However, the molecules of liquid crystal are vertically aligned with respect to the surface of the substrate in an initial state, and then are horizontally aligned by the application of a voltage. Therefore, if there are no measures to align the liquid crystal molecules (if the liquid crystal molecules are pre-tilted), it is impossible to control the inclined direction of the liquid crystal molecules. As a result, a display defect, such as light leakage caused by the alignment disorder (disclination) of liquid crystal, occurs, resulting in the deterioration of display characteristics. Thus, it is important to control the alignment directions of the liquid crystal molecules at the time when a voltage is applied in the vertical alignment mode.

In the liquid crystal display device 100 of the present exemplary embodiment, by forming projections (convex portions or device for giving convex shapes on a surface facing to the liquid crystal layer) made of a dielectric material, such as acrylic resin, on the surface facing to the liquid crystal layer 50, the liquid crystal molecules are pre-tilted corresponding to the convex shapes. An inclined electric field is generated between electrodes opposite to each other by forming the electrodes each having slits therein, thereby pre-tilting the liquid crystal molecules by the inclined electric field. Specifically, as shown in FIG. 3, slits 49 (portions represented by a dashed line in FIG. 3) are formed in each of the common electrodes 9 by cutting off a portion of the common electrode 9 in a longitudinal or rectangular shape, and the projections 28 made of a dielectric material are formed on the inner surface of the upper substrate 25 so as to protrude from the pixel electrode 31 toward the inside of the liquid crystal layer 50.

Particularly, in the present exemplary embodiment, the slits 49 formed in the common electrodes 9 and the projections 28 formed in the inner surface of the upper substrate 25 are located far apart from each other. A projection 28 is located between adjacent slits 49 out of a plurality of the slits 49 in plan view. Therefore, a region in which the inclined direction of the liquid crystal molecules becomes discontinuous is hardly formed between adjacent slits or between adjacent projections. Thus it is possible to more effectively prevent or suppress the generation of disclination.

Further, in the present exemplary embodiment, the pixel electrode 31 is opened at positions in which the projections 28 to control or regulate the alignment directions of the liquid crystal molecules are formed. Thus the electrode does not exist on the inner surface and outer surface of the projection 28. Therefore, since the direction in which the liquid crystal molecules are inclined is opposite to the direction of the electric line of force under the influence of the projections 28, the direction in which the liquid crystal molecules are inclined is easily determined, and thus it is possible to more stably control the alignment directions of the liquid crystal molecules. In addition, it is possible to control the alignment directions of the liquid crystal molecules by directly forming the projections 28 on the pixel electrodes 31.

In this way, the liquid crystal molecules are vertically aligned in an initial state, and are then pre-tilted by the inclined electric field generated due to the convex shapes of the projections 28 and the formation of the slits 49. As a result, it is possible that the liquid crystal molecules are inclined in a predetermined direction, and thus to reduce the likelihood or prevent the generation of a display defect, such as light leakage caused by the alignment disorder (disinclination) of the liquid crystal molecules. In addition, it is possible to suppress display defects, such as a residual image and color unevenness, and to provide a liquid crystal display device having a wide viewing angle.

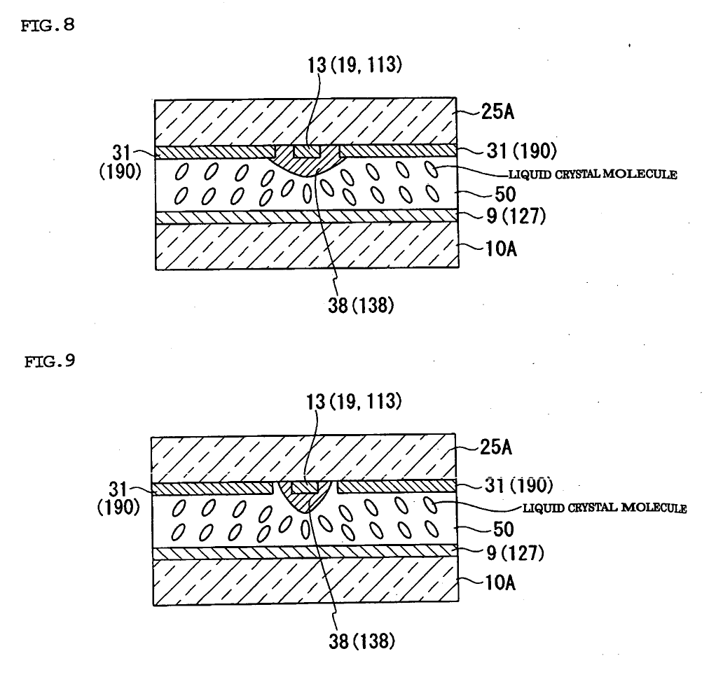

In the liquid crystal display device 100, as shown in FIG. 3(a), the projections 38 made of a dielectric material, such as acrylic resin, are arranged on the signal lines through which signals are supplied to the pixel electrodes 31, specifically, on the scanning lines 13 through which the scanning signals are supplied to the pixel electrodes 31 via TFD elements. Particularly, as shown in the plan view of FIG. 8, the projection 38 is laid across the scanning line 13 and the pixel electrode 31 so as to cover the scanning line 13 in plan view. In addition, the projection 38 is formed so as to cover a portion of the edge of the pixel electrode 31 (also see FIG. 2).

For example, when the projection 38 is not formed, a horizontal electric field may be generated between the pixel electrode 31 and the scanning line 13 through which signals are supplied to the pixel electrode 31. When the horizontal electric field is generated, the liquid crystal molecules may be aligned differently from a normal alignment by the electric field commonly generated between the pixel electrode 31 and the common electrode 9. As such, when the liquid crystal molecules are aligned in a direction different from the normal direction by the horizontal electric field, the alignment of the liquid crystal molecules may be disordered, specifically, in the peripheral region of the pixel. The deterioration of display characteristics may occur even if the alignment regulation on the liquid crystal molecules is performed by forming the projections 28 and the slits 49 in the pixels as described above.

As shown in FIGS. 3(a) and 8, in the present exemplary embodiment, the projections 38 (the convex portions or the device for giving convex shapes on a surface facing to the liquid crystal layer) made of a dielectric material are formed on the scanning lines 13. Thus the scanning lines 13 are electrically isolated from the pixel electrodes 31. Thus, it is possible to prevent or suppress the generation of the horizontal electric field. Even when the horizontal electric field is generated, it is possible to align, in a predetermined direction, the liquid crystal molecules in the vicinity of the region in which the scanning line 13 is formed, by alignment regulating force generated due to the convex shape of the projection 38 without being affected by the horizontal electric field, specifically, by the alignment regulating force generated due to the convex shape of the projection 38 that has a larger influence on the liquid crystal molecules than the horizontal electric field. Therefore, it is possible to control or regulate the inclined direction of the liquid crystal molecules, specifically, in the vicinity of the region in which the scanning line 13 is formed, and thus to reduce the likelihood or prevent the generation of a display defect, such as light leakage caused by alignment disorders (disclination), thereby preventing the generation of display defects, such as a residual image and color unevenness. In addition, it is possible to provide a liquid crystal display device having a wide viewing angle.

The projections 28 and 38 used in the present exemplary embodiment can be made of the same material and be formed by the same process. The projections 28 and 38 function as the device for giving convex shapes on a surface facing to the liquid crystal layer 50. Specifically, the projections 28 and 38 each have a mountain-shaped incline plane protruding from the inner surface of the substrate towards the liquid crystal layer 50 at a predetermined height (for example, a height of 0.05 μm to 1.5 μm, and preferably, a height of 0.07 μm to 0.2 μm).

The projections 28 and 38 each have a substantially symmetric longitudinal section. For example, when the projections 28 and 38 whose longitudinal sections are substantially triangular shapes are formed in a longitudinal shape, the respective liquid crystal molecules are inclined in the direction opposite to each other with respect to the center (the vertex) of the projection being the boundary. Thus, it is possible to obtain a wide viewing angle characteristic. As such, in order to obtain the wide viewing angle characteristic, the projections 28 and 38 may each have a longitudinal section of a truncated pyramid shape or a semi-elliptic shape other than the triangular shape.

Second Exemplary Embodiment

A second exemplary embodiment of the present invention will now be described with reference to the drawings.

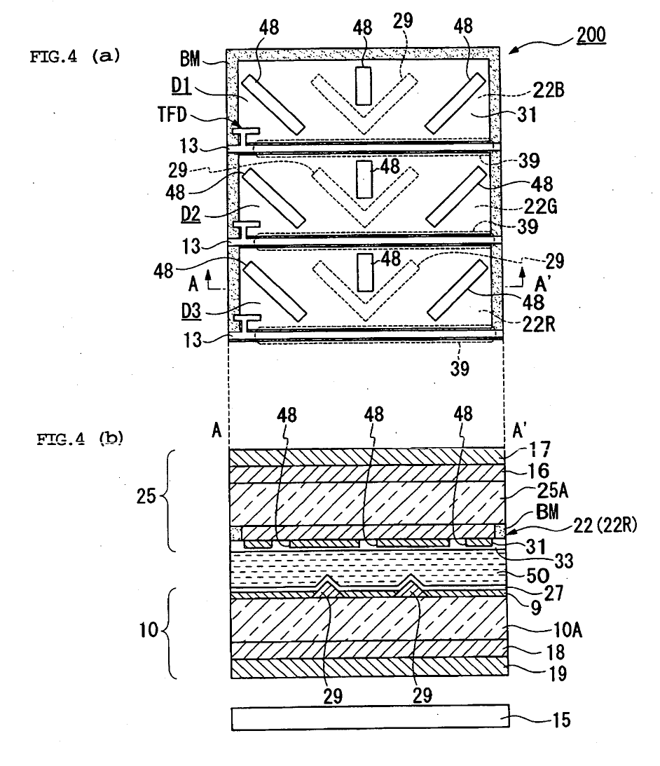

FIGS. 4(a) and 4(b) are schematics illustrating a liquid crystal display device 200 according to the second exemplary embodiment, and correspond to FIGS. 3(a) and 3(b) of the first exemplary embodiment. The basic structure of the liquid crystal display device according to the second exemplary embodiment is the same as that of the first exemplary embodiment. But positions in which the dielectric projections and electrode slits to control the alignment of liquid crystal molecules are formed are different from that of the first exemplary embodiment. In FIGS. 4(a) and 4(b), the same components as those in FIGS. 3(a) and 3(b) have the same reference numerals, and a detailed description thereof will be omitted.

As shown in FIGS. 4(a) and 4(b), in the liquid crystal display device 200 according to the second exemplary embodiment, slits 48 are provided in the pixel electrodes 31 formed on the inner surface of the upper substrate 25, and projections 29 are formed on the inner surface of the lower substrate 10. In this case, the slit 48 is an opening having a longitudinal or rectangular shape in plan view that is formed by cutting off a portion of the pixel electrode 31. The projection 29 is a longitudinal or rectangular convex portion (device for giving a convex shape on a surface facing to the liquid crystal layer) made of a dielectric material, such as acrylic resin, and the projection 29 has a substantially triangular longitudinal section. In this case, it is also possible to pre-tilt the liquid crystal molecules in accordance with the convex shapes of the projections 29, and to pre-tilt the liquid crystal molecules by the inclined electric field generated by the slits 48.

Furthermore, the slits 48 formed in the pixel electrode 31 and the projections 29 formed on the inner surface of the lower substrate 10 are located far apart from each other. Specifically, the projection 29 is arranged between adjacent slits 48 out of a plurality of the slits 48 in plan view. Therefore, a discontinuous region causing the liquid crystal molecules to be aligned in the opposite direction is hardly generated between adjacent projections or adjacent slits. The common electrode 31 is opened at positions corresponding to the projections 29 to control or regulate the alignment direction of the liquid crystal molecules, that is, the electrode does not exist on the inner surface of the projection 29.

By arranging the projections 29 and the slits 48 as described above, the liquid crystal molecules that are vertically aligned in an initial state are pre-tilted by the inclined electric field generated due to the convex shapes of the projections 29 and the formation of the slits 48. Therefore, it is possible to control or regulate the liquid crystal molecules to be inclined in a predetermined direction, and thus to reduce the likelihood or prevent the generation of a display defect, such as light leakage caused by the alignment disorder (disinclination) of liquid crystal, thereby suppressing the generation of display defects, such as a residual image and color unevenness. In addition, it is possible to provide a liquid crystal display device having a wide viewing angle.

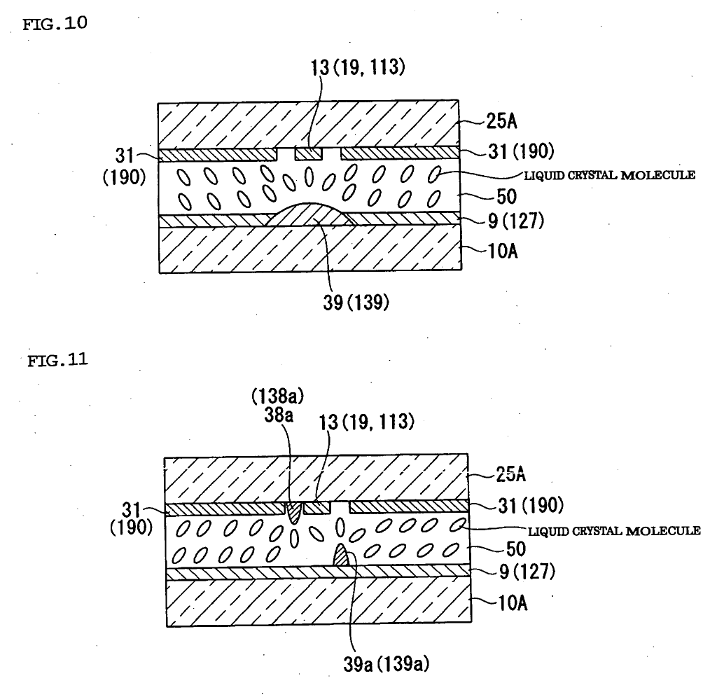

As shown in FIG. 4(a), the projections 39 made of a dielectric material, such as acrylic resin, are arranged on the inner surface of another substrate (the lower substrate 10) other than the substrate (the upper substrate 25) on which the scanning lines 13 are formed such that they overlap in plan view with the scanning lines 13 through which scanning signals are supplied to the pixel electrodes 31 via TFDs, specifically, such that they cover the scanning lines 13 in plan view. More specifically, as shown in FIG. 10, the projection 39 is formed on the lower substrate 10 so as to overlap with the scanning line 13 in plan view. In addition, the projection 39 is also formed so as to overlap with a portion of the outer circumference of the pixel electrode 31.

As described above, the horizontal electric field may be generated between the pixel electrode 31 and the scanning line 13 through which signals are supplied to the pixel electrode 31. When the horizontal electric field is generated, the liquid crystal molecules may be differently aligned from the normal alignment by the electric field commonly generated between the pixel electrode 31 and the common electrode 9. When the liquid crystal molecules are aligned in a direction different from the normal alignment direction by the horizontal electric field, the alignment of the liquid crystal molecules is disordered, specifically, in the peripheral region of the pixel. The deterioration of display characteristics may occur even if the alignment control on the liquid crystal molecules is performed by forming the projections 28 and the slits 49 in each pixel as described above.

As shown in FIGS. 4(a) and 10, in the present exemplary embodiment, the projections 39 (the convex portions or the device for giving the convex shapes on the surface facing to the liquid crystal layer) made of a dielectric material are arranged on the inner surface of another substrate (the lower substrate 10) other than the substrate (the upper substrate 25) on which the scanning lines 13 are formed such that they overlap with the scanning lines 13 in plan view. Thus, even when the horizontal electric field is generated, it is possible to align, in a predetermined direction, the liquid crystal molecules in the vicinity of the region in which the scanning line 13 is formed, by alignment regulating force generated due to the convex shape of the projection 39 without being affected by the horizontal electric field, specifically, by the alignment regulating force generated due to the convex shape of the projection 39 that has a larger influence on the liquid crystal molecules than the horizontal electric field. Therefore, it is possible to control or regulate the inclined direction of the liquid crystal molecules, specifically, in the vicinity of the region in which the scanning line 13 is formed, and thus to reduce the likelihood or prevent the generation of a display defect, such as light leakage caused by the alignment disorder (disclination) of liquid crystal, thereby suppressing the generation of display defects, such as a residual image and color unevenness. In addition, it is possible to provide a liquid crystal display device having a wide viewing angle.

The projections 29 and 39 formed on the inner surface of the lower substrate 10 can be made of the same material and be formed by the same process. The projections 29 and 39 each function as the device for giving the convex shapes on the surface facing to the liquid crystal layer 50. Specifically, the projections 29 and 39 each have a mountain-shaped incline plane protruding from the inner surface of the substrate towards the liquid crystal layer 50 at a predetermined height (for example, a height of 0.05 μm to 1.5 μm, and preferably, a height of 0.07 μm to 0.2 μm).

Further, the projections 29 and 39 each have a substantially symmetric longitudinal section. For example, when the projections 29 and 39 each having a substantially triangular longitudinal section are formed in a longitudinal shape, the respective liquid crystal molecules are inclined in the direction opposite to each other with respect to the center (the vertex) of the projection being the boundary. Thus, it is possible to obtain a wide viewing angle characteristic. As such, in order to obtain the wide viewing angle characteristic, the longitudinal section of each of the projections 29 and 39 may have a truncated pyramid shape, a semicircular shape, or a semi-elliptic shape other than the triangular shape.

Third Exemplary Embodiment

Hereinafter, a third exemplary embodiment of the present invention will be described with reference to the drawings.

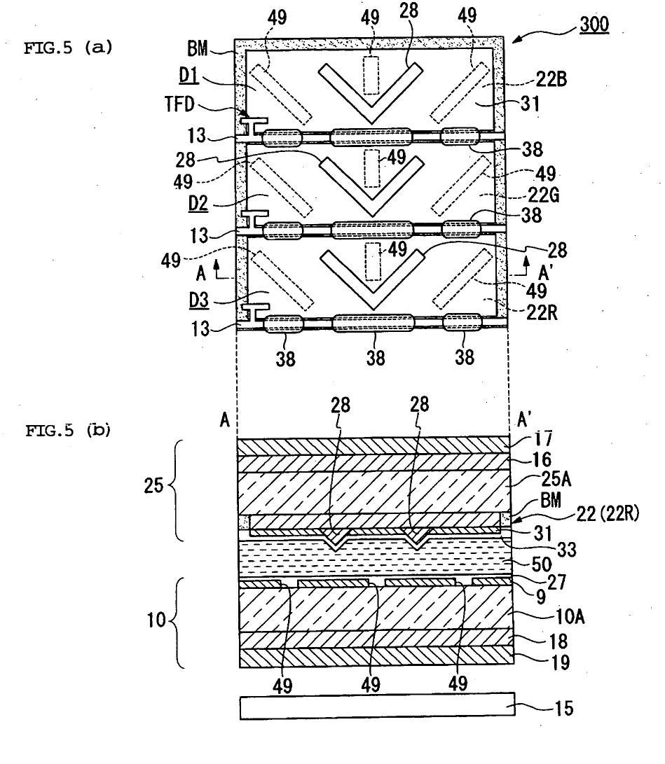

FIGS. 5(a) and 5(b) are schematics illustrating a liquid crystal display device 300 according to the third exemplary embodiment, and correspond to FIGS. 3(a) and 3(b) of the first exemplary embodiment. The basic structure of the liquid crystal display device according to the third exemplary embodiment is the same as that of the first exemplary embodiment, but the structure of the projections formed on the scanning lines is mainly different from that of the first exemplary embodiment. In FIG. 5, the same components as those in FIG. 3 have the same reference numerals, and a detailed description thereof will be omitted.

As shown in FIG. 5(a), in the liquid crystal display device 300 according to the third exemplary embodiment, a plurality of projections 38 made of a dielectric material, such as acrylic resin, are formed in one pixel on the scanning line 13 through which scanning signals are supplied to the pixel electrode 31 via a TFD. Specifically, the plurality of projections 38 each having a point shape or rectangular shape, are formed in one dot region D1, D2, or D3, or in the boundary regions between D1, D2, and D3.

In this case, similar to the first exemplary embodiment, it is also possible to isolate the scanning line 13 from the pixel electrode 31, and thus to reduce the likelihood or prevent the generation of the horizontal electric field between the scanning line 13 and the pixel electrode 31. Even when the horizontal electric field is generated, it is possible to align, in a predetermined direction, the liquid crystal molecules in the vicinity of the region in which the scanning line 13 is formed, by the alignment regulating force generated due to the convex shape of the projection 38 without being affected by the horizontal electric field, specifically, by the alignment regulating force generated due to the convex shape of the projection 38 that has a larger influence on the liquid crystal molecules than the horizontal electric field. Therefore, it is possible to control or regulate the inclined direction of the liquid crystal molecules, specifically, in the vicinity of the region in which the scanning line 13 is formed, and thus to reduce the likelihood or prevent the generation of a display defect, such as light leakage caused by the alignment disorder (disclination) of liquid crystal, thereby suppressing the generation of display defects, such as a residual image and color unevenness. In addition, it is possible to provide a liquid crystal display device having a wide viewing angle.

The projections 28 and 38 formed on the inner surface of the upper substrate 25 can be made of the same material and be formed by the same process. The projections 28 and 38 each function as the device for giving the convex shapes on the surface facing to the liquid crystal layer 50. Specifically, the projections 28 and 38 each have a mountain-shaped incline plane protruding from the inner surface of the substrate towards the liquid crystal layer 50 at a predetermined height (for example, a height of 0.05 μm to 1.5 μm, and preferably, a height of 0.07 μm to 0.2 μm). The projections 28 and 38 each have a substantially symmetric longitudinal section, similar to the first exemplary embodiment.

Fourth Exemplary Embodiment

Hereinafter, a fourth exemplary embodiment of the present invention will be described with reference to the drawings.

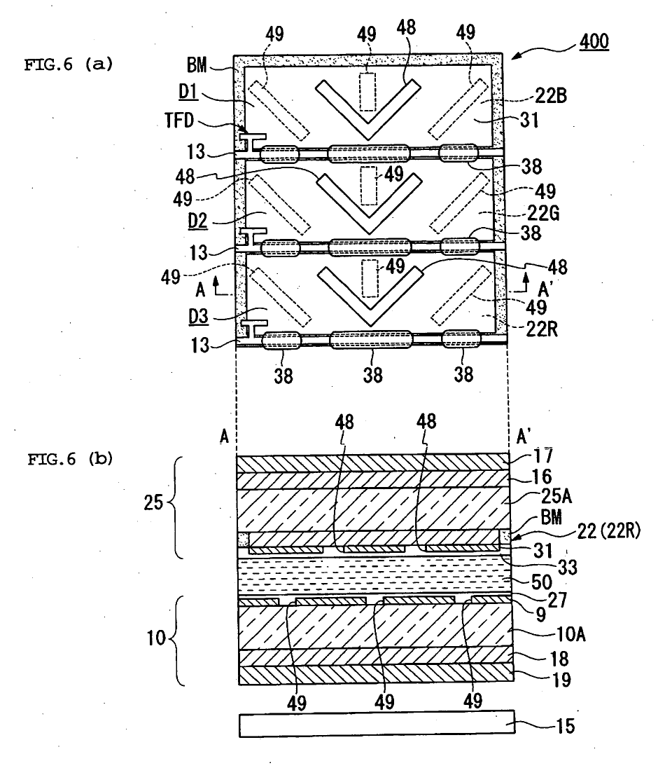

FIGS. 6(a) and 6(b) are schematics illustrating a liquid crystal display device 400 according to the fourth exemplary embodiment, and correspond to FIGS. 3(a) and 3(b) of the first exemplary embodiment. The basic structure of the liquid crystal display device according to the fourth exemplary embodiment is the same as that of the first exemplary embodiment. But the structure of the projections or the slits to control the alignment of the liquid crystal molecules is mainly different from that of the first exemplary embodiment. In FIG. 6, the same components as those in FIG. 3 have the same reference numerals, and a detailed description thereof will be omitted.

As shown in FIG. 6, in the liquid crystal display device 400 according to the fourth exemplary embodiment, the slits 48 are provided in the pixel electrodes 31 formed on the inner surface of the upper substrate 25, and slits 49 are formed in the common electrodes 9 formed on the inner surface of the lower substrate 10. In this case, the slit 48 or 49 is an opening having a longitudinal or rectangular shape in plan view that is formed by cutting off a portion of each pixel electrode 31 or 9. Therefore, it is also possible to pre-tilt the liquid crystal molecules using the alignment regulating force generated due to the formation of the slits. In addition, the slit 48 formed in the pixel electrode 31 and the slits 49 formed in the common electrode 9 are located far apart from each other. Specifically, the slit 49 opposite to the slit 48 is arranged between adjacent slits 48 out of a plurality of the slits 48 in plan view. Therefore, a discontinuous region causing the liquid crystal molecules to be aligned in the opposite direction is hardly generated between adjacent slits.

As shown in FIG. 6(a), the projections 38 made of a dielectric material, such as acrylic resin, are formed on the scanning lines 13 through which scanning signals are supplied to the pixel electrodes 31 via the TFDs. In this case, it is also possible to reduce the likelihood or prevent the generation of the horizontal electric field between the scanning line 13 and the pixel electrode 31 by forming the projections 38. Even when the horizontal electric field is generated, it is possible to align, in a predetermined direction, the liquid crystal molecules in the vicinity of the region in which the scanning line 13 is formed, by the alignment regulating force generated due to the convex shape of the projection 38 without being affected by the horizontal electric field, specifically, by the alignment regulating force generated due to the convex shape of the projection 38 that has a larger influence on the liquid crystal molecules than the horizontal electric field.

According to the present exemplary embodiment, the projections are not formed inside the pixels, and the alignment of the liquid crystal molecules is regulated by only the electrode slits. Therefore, the projections 38 are formed by an independent manufacturing process, but may be formed by the same manufacturing process as spacers (not shown) for defining the thickness of the liquid crystal layer 50. In a display device in which so-called scallop-shaped photo-spacers are formed on the inner surface of a substrate, the projections 38 can be simultaneously formed with the spacers on the scanning lines 13. The projections 38 can be formed as a device to regulate the alignment directions of the liquid crystal molecules, and can also be formed as a device to regulate the thickness of the liquid crystal layer. Further, the projections 38 can be formed to perform both functions.

Fifth Exemplary Embodiment

Hereinafter, a fifth exemplary embodiment of the present invention will be described with reference to the drawings.

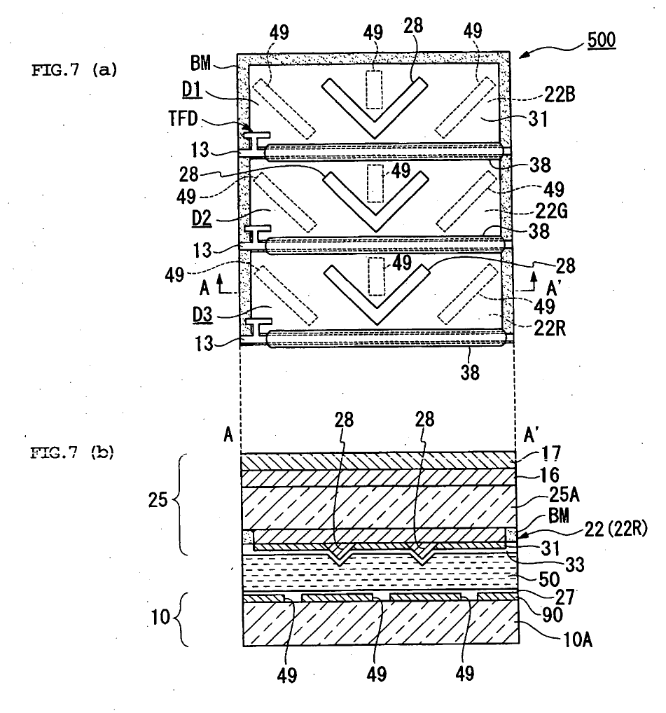

FIGS. 7(a) and 7(b) are schematics illustrating a liquid crystal display device 500 according to the fifth exemplary embodiment, and correspond to FIGS. 3(a) and 3(b) of the first exemplary embodiment. The basic structure of the liquid crystal display device according to the fifth exemplary embodiment is the same as that of the first exemplary embodiment. But the fifth exemplary embodiment is different from the first exemplary embodiment in that common electrodes 90 formed on the inner surface of the lower substrate 10 are composed of a reflective metal film. In FIG. 7, the same components as those in FIG. 3 have the same reference numerals, and a detailed description thereof will be omitted.

As shown in FIG. 7, in the liquid crystal display device 500 according to the fifth exemplary embodiment, the common electrodes 90 formed on the inner surface of the lower substrate 10 are composed of the reflective metal film, and the slits 49 are formed in each of the common electrodes (the reflective film) 90. In addition, a retardation film, a polarizing film, a backlight, and the like are not formed on the outer surface of the lower substrate 10, and image display can be performed by reflecting external light, such as sunlight or illumination light, incident on the outer surface of the upper substrate 25 from the pixel electrodes (the reflective film) 90. The liquid crystal display device 500 according to the fifth exemplary embodiment is a reflective liquid crystal display device adopting a vertical alignment mode.

In the liquid crystal display device adopting the vertical alignment mode, the alignment of the liquid crystal molecules inside the pixels is regulated by forming the slits 49 in the common electrodes (the reflective film) 90 and by forming the projections 28 on the inner surface of the upper substrate 25, and the alignment of the liquid crystal molecules in the regions around the pixels is also regulated by forming projections 38 on the scanning lines 13.

In this case, since the slit 49 is an opening having a longitudinal or rectangular shape in plan view that is formed by cutting off a portion of the common electrode (the reflective film) 90, it is also possible to pre-tilt the liquid crystal molecules using the alignment regulating force generated due to the formation of the slits. In addition, since the projections 28 protrude towards the liquid crystal layer 50, the inclined direction of the liquid crystal molecules is regulated by the convex shapes of the projections 28, specifically, by the incline planes of the projections 28. Further, the slits 49 formed in the common electrode 9 and the projections 49 formed on the inner surface of the upper substrate 25 are located far apart from each other. Specifically, the projection 28 opposite to the slit 49 is arranged between adjacent slits 49 out of a plurality of the slits 49 in plan view. Therefore, a discontinuous region causing the liquid crystal molecules to be aligned in the opposite direction is hardly generated between adjacent slits.

Further, the projection 38 formed on the scanning line 13 is made of a dielectric material, such as acrylic resin, and protrudes from the inner surface of the upper substrate 25 towards the liquid crystal layer 50 to isolate the scanning line 13 from the pixel electrode 31. The projection 38 can regulate the inclined direction of the liquid crystal molecules by its convex shape, specifically, by its incline planes, in addition to the effect of the electrical isolation. Therefore, it is possible to prevent or suppress the generation of the horizontal electric field between the pixel electrode 31 and the scanning line 13 by forming the projection 38. Even when the horizontal electric field is generated, it is possible to regulate the alignment directions of the liquid crystal molecules by the alignment regulating force generated due to the convex shape of the projection 38 that is stronger than the horizontal electric field.

As described in the first to fifth exemplary embodiments, the projection (38 or 39) formed on or overlapped with the scanning line 13 can be formed at an appropriate position or have an appropriate shape according to the inclination direction of the liquid crystal molecules. The projections 28 and 29 and the electrode slits 48 and 49 can be selectively formed at appropriate positions according to the inclination direction of the liquid crystal molecules. For example, as shown in FIG. 9, by forming the projection 38 so as to cover the scanning line 13 formed between adjacent pixel electrodes 31, it is possible to prevent or suppress the generation of the horizontal electric field, and to regulate the alignment of the liquid crystal molecules based on the convex shape of the projection 38. Further, as shown in FIG. 8, by forming the projection 38 so as to cover portions of the outer circumferences of the respective pixel electrodes 31, it is possible to more effectively reduce the likelihood or prevent the generation of the horizontal electric field.

As shown in FIG. 10, even if the projection 39 is formed on a substrate 10A other than the substrate 25A on which the scanning line 13 is formed between adjacent pixel electrodes 31 so as to overlap with the scanning line 13 in plan view, the projection 39 may overlap with portions of the outer circumferences of adjacent pixel electrodes 31 in plan view. In this case, it is possible to further reduce the influence of the horizontal electric field on the liquid crystal molecules between the pixel electrode 31 and the scanning line 13, by the alignment regulating force generated due to the convex shape of the projection.

Further, as shown in FIG. 11, a projection may be formed in the vicinity of the scanning line 13, and a projection 38a may be formed between the pixel electrode 31 and the scanning line 13 without covering the scanning line 13. In addition, even when a projection is formed on the side opposite to the scanning line 13, a projection 39a is not necessarily formed to overlap with the scanning line 13 in plan view. But it may be formed on a substrate opposite to the substrate on which the scanning lines 13 and the pixel electrodes 31 are formed so as to be arranged between the scanning line 13 and the pixel electrode 31 in plan view.

Sixth Exemplary Embodiment

Hereinafter, a sixth exemplary embodiment of the present invention will be described with reference to the drawings.

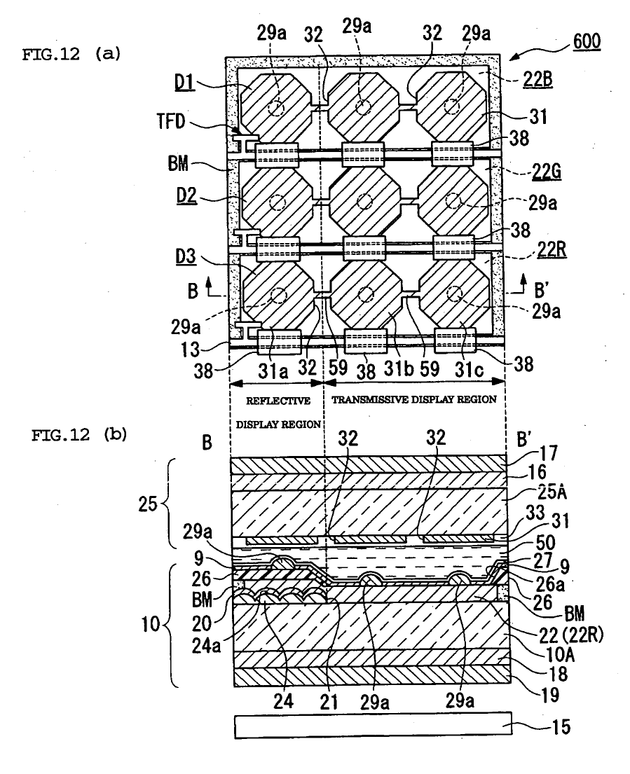

FIGS. 12(a) and 12(b) are schematics illustrating a liquid crystal display device 600 according to the sixth exemplary embodiment, and correspond to FIGS. 3(a) and 3(b) of the first exemplary embodiment. The basic structure of the liquid crystal display device according to the sixth exemplary embodiment is the same as that of the first exemplary embodiment. But the sixth exemplary embodiment is different from the first exemplary embodiment in that a reflective film is partially formed on the inner surface of the lower substrate 10 to perform both transmissive display and reflective display. In FIG. 12, the same components as those in FIG. 3 have the same reference numerals, and a detailed description thereof will be omitted.

As shown in FIG. 12, in the liquid crystal display device 600 according to the present exemplary embodiment, a reflective film 20 is partially formed on the inner surface of the lower substrate 10 to perform the reflective display in a region in which the reflective film 20 is formed and to perform the transmissive display in a region (an opening region of the reflective film 20) in which the reflective film 20 is not formed. The liquid crystal display device 600 of the present exemplary embodiment is a transflective liquid crystal display device adopting a vertical alignment mode.

Further, as shown in FIG. 12(b), in the liquid crystal display device 600 of the present exemplary embodiment, a liquid crystal layer 50 composed of liquid crystal that is vertically aligned in an initial state, specifically, that has negative dielectric anisotropy, is interposed between the upper substrate (the element substrate) 25 and the lower substrate (the counter substrate) 10 opposite to the upper substrate 25, similar to the liquid crystal display device 100 of the first exemplary embodiment.

The lower substrate 10 has a structure in which a reflective film made of a metallic material having high reflectance, such as silver or aluminum, is partially formed on the surface of the substrate body 10A made of a transmissive material, such as quartz or glass, with an insulating film 24 interposed therebetween. Herein, a region in which the reflective film is form is a reflective display region R, and a region in which the reflective film is not formed, that is, an inside region of an opening 21 in the reflective film 20, is a transmissive display region T.

The insulating film 24 formed on the substrate body 10A has an uneven portion 24a thereon, and the surface of the reflective film 20 has an uneven shape according to the uneven portion 24a. Since reflected light is scatter by the uneven shape, light reflection from the outside is reduced or prevented and thus it is possible to perform reflective display in a wide viewing angle range. The insulating film 24 having the uneven portion 24a thereon is formed by patterning a resin resist and by further applying resin on the patterned resist. In addition, heat treatment may be performed on the patterned resist to form the desired shape.

A color filter 22 (only a red colored layer 22R is shown in FIG. 12(b)) is formed on the reflective film 20 located in the reflective display region R and on the substrate body 10A in the transmissive display region T so as to be laid across the reflective display region R and the transmissive display region T. Herein, the edge of the red colored layer 22R is surrounded with a black matrix BM made of a metallic material, such as chrome, and the boundaries between the respective dot regions D1, D2, and D3 are defined by the black matrix BM (see FIG. 12(a)).

Furthermore, an insulating film 26 is formed on the color filter 22 at a position corresponding to the reflective display region R. The insulating film 26 is selectively formed on the reflective film 20 with the color filter 22 interposed therebetween. The thickness of the liquid crystal layer 50 in the reflective display region R is different from that in the transmissive display region T due to the formation of the insulating film 26. The insulating film 26 is formed of an organic film made of acrylic resin and has a thickness 0.5 μm to 2.5 μm. In addition, the insulating film 26 has an incline plane in which its thickness is continuously varied in the vicinity of the boundary between the reflective region R and the transmissive region T. The thickness of the liquid crystal layer 50 in a region in which the insulating film 26 does not exist is in the range of 1 μm to 5 μm, and the thickness of the liquid crystal layer 50 in the reflective display region R is about half the thickness of the liquid crystal layer 50 in the transmissive display region T. That is, since the thickness of liquid crystal layer 50 in the reflective display region R is different from that in the transmissive display region T due to the thickness of the insulating film 26, the insulating film 26 functions as a layer to adjust the thickness of a liquid crystal layer (a layer to control the thickness of a liquid crystal layer).

Further, a projection (a convex portion) 29a protruding from the insulating film 26 toward the inside of the liquid crystal layer 50 is formed at the substantially central position of the insulating film 26 formed in the reflective display region R in plan view. The projection 29a is made of a dielectric material, such as acrylic resin, and functions as convex shape-giving device to give a convex shape having an incline plane on the surface facing to the liquid crystal layer 50. Specifically, the projection 29a protrudes from the insulating film 26 with a predetermined height (for example, a height of 0.05 μm to 1.5 μm, and preferably, a height of 0.07 μm to 0.2 μm).

The projections (the convex portions) 29a protruding from the color filter 22 toward the inside of the liquid crystal layer 50 are formed on the color filter 22 at positions corresponding to the transmissive display region T. Each of the projections 29a is made of a dielectric material, such as acrylic resin, which is the same material as used in the reflective display region R. The projection 29a functions as the convex shape-giving device to give a convex shape having an incline plane on the surface facing to the liquid crystal layer 50. Specifically, the projection 29a protrudes from the insulating film 26 with a predetermined height (for example, a height of 0.05 μm to 1.5 μm, and preferably, a height of 0.07 μm to 0.2 μm). That is, the projections 29a each formed in the reflective display region R and the transmissive display region T are formed by the same manufacturing process and are made of the same material, that is, a dielectric material composed of an organic film, such as acrylic resin.

Furthermore, a stripe-shaped common electrode 9 made of indium tin oxide (hereinafter, “ITO”) is formed on the color filter 22 including the insulating film 26 and the projections 29a, and an alignment film 27 made of polyimide is formed on the common electrode 9. The alignment film 27 functions as a vertical alignment film to allow liquid crystal molecules to be vertically aligned with respect to the surface of the film, but an alignment process, such as a rubbing process, is not performed thereon. In FIG. 12, the common electrode 9 is formed in a stripe shape extending to the direction perpendicular to the paper, and is common to the respective dot regions formed parallel to the direction perpendicular to the paper. In the present exemplary embodiment, the reflective film 20 is separately formed from the common electrode 9. However, the reflective film composed of a metal film may be used as a portion of the common electrode in the reflective display region R. The common electrode 9 is not formed on the inner and outer surfaces of each of the projections 29a, and the projections 29a are formed inside the openings of the common electrode 9.

Next, as for the upper substrate 25, matrix-shaped pixel electrodes 31 composed of a transparent conductive film, such an ITO film, and an alignment film 33 subjected to the same vertical alignment process as the lower substrate 10 made of polyimide are sequentially formed on the substrate body 25A (on the liquid crystal layer side of the substrate body 25A) made of a transmissive material, such as glass or quartz. In addition, a slit 32 is formed in the each pixel electrode 31 by cutting off a portion of the pixel electrode 31.

Further, a retardation plate 18 and a polarizing plate 19 are sequentially formed on the outer surface of the lower substrate 10, and a retardation plate 16 and a polarizing plate 17 are sequentially formed on the outer surface of the upper substrate 25 such that circularly polarized light can be incident on the inner surface of the substrate (on the side of the liquid crystal layer 50). A combination of the retardation plate 18 and the polarizing plate 19 and a combination of the retardation plate 16 and the polarizing plate 17 each constitute a circularly polarizing plate.

In the liquid crystal display device 600 according to the present exemplary embodiment, the projections 29a are formed on the inner surface (the surface facing to the liquid crystal layer 50) of the lower substrate 10 in order to regulate the alignment of the liquid crystal molecules in the liquid crystal layer 50, specifically, in order to regulate a direction in which the liquid crystal molecules each having a vertical alignment in an initial state are inclined at the time when a voltage is applied between the electrodes. More specifically, in FIG. 12, the projections 29a, each protruding toward the inside of the liquid crystal layer 50, are formed on the inner surface (the surface facing to the liquid crystal layer) of the color filter 22 in both the reflective display region R and the transmissive display region T, and have truncated cone shapes.

The projections 29a formed as described above regulate the inclined direction of the liquid crystal molecules using their convex shapes (particularly, their incline planes). The liquid crystal molecules are vertically aligned in an initial state when no voltage is applied. Then, when a voltage is applied thereon, the liquid crystal molecules are inclined in a direction intersecting with the direction of the electric field. However, according to the present exemplary embodiment, when a voltage is applied, the inclined direction of the liquid crystal molecules are regulated along the incline planes of the projections 29a.

The surface (the incline plane) of the projection 29a may be inclined at a predetermined angle with respect to the direction in which the liquid crystal molecules are vertically aligned. For example, the projection 29a may be formed in a cone shape, an elliptical cone shape, a polygonal pyramid shape, a truncated cone shape, a truncated elliptical cone shape, a truncated polygonal pyramid shape, or a semicircular shape. In addition, the incline plane of the projection 29a may have the maximum inclination angle of 2° to 20°. In this case, the inclination angle is an angle formed between the incline plane of the projection 29a and the surface (the main surface) of the substrate 10A. When the projection 29a has a curved surface, the inclination angle indicates an angle formed between the surface of the substrate and a surface tangent to the curved surface of the projection 29a. In this case, when the maximum inclination angle is less than 2°, it may be difficult to regulate the alignment directions of the liquid crystal molecules. When the maximum inclination angle is more than 20°, light leakage may be generated from that portion, resulting in a display defect, such as the deterioration of contrast.

The slit 32 is formed in each pixel electrode 31 formed on the inner surface (the surface facing to the liquid crystal layer) of the upper substrate 10 in order to regulate the alignment of the liquid crystal molecules in the liquid crystal layer 50. By forming the slit 32 in the pixel electrode 31, an inclined electric field is generated between the pixel electrode 31 and the common electrode 9 opposite thereto at the position where the slit 32 is formed. Thus, the inclined electric field enables the inclined direction of the liquid crystal molecules to be regulated.

Furthermore, by forming the slit 32 in the pixel electrode 31, the pixel electrode 32 is divided into substantially octagonal sub-dots (island-shaped portions) 31a, 31b, and 31c, and the respective sub-dots (the island-shaped portions) 31a, 31b, and 31c are connected to each other by connection portions 59. The projections 29a are formed on the inner surface of the lower substrate 10 so as to be opposite to the substantially central parts of the respective sub-dots (the island-shaped portions) 31a, 31b, and 31c. As a result, the liquid crystal molecules are inclined in all directions with respect to the center of the projection 29a. That is, according to the present exemplary embodiment, the alignment is divided by each sub-dot (the island-shaped portion) 31a, 31b, and 31c.

Moreover, in the liquid crystal display device 600 of the present exemplary embodiment, projections 38 made of a dielectric material are formed on each scanning line 13 formed on the inner surface of the upper substrate 25. Specifically, the projections 38 are formed on the scanning line 13 so as to cover the scanning line 13 in fragments. As such, by forming the projections 38 (the convex portions or device for giving convex shapes on the surface facing to the liquid crystal layer) made of a dielectric material on the scanning line 13, the scanning line 13 is isolated from the pixel electrode 31, and thus it is possible to prevent or suppress the generation of the horizontal electric field therebetween. Even when the horizontal electric field is generated, it is possible to align, in a predetermined direction, the liquid crystal molecules in the vicinity of the region in which the scanning line 13 is formed, by the alignment regulating force generated due to the convex shape of the projection 38 without being influenced by the horizontal electric field, specifically, by the alignment regulating force generated due to the convex shape of the projection 38 that has a larger influence on the alignment of the liquid crystal molecules than the horizontal electric field.

Further, the projections 38 each have a substantially symmetric longitudinal section. For example, when the projections 38 each having a substantially triangular longitudinal section are formed in a longitudinal shape, the respective liquid crystal molecules are inclined in the direction opposite to each other with respect to the center (the vertex) of the projection being the boundary. Thus, it is possible to obtain a wide viewing angle characteristic. As such, in order to obtain the wide viewing angle characteristic, the longitudinal section of the projection 38 may have a truncated pyramid shape, or a semi-elliptic shape other than the triangular shape.

Furthermore, according to the present exemplary embodiment, as shown in FIG. 12(a), the projections 38 are formed so as to cover the scanning line 13 in fragments at positions where the pixel electrode 31 having a substantially octagonal shape is closest to the scanning line 13. Since the horizontal electric field is easily generated at a position where the pixel electrode 31 is closest to the scanning line 13, the alignment of the liquid crystal molecules can be more effectively regulated by forming the projections 38 at that position.

According to the liquid crystal display device 600 of the present exemplary embodiment having the above-mentioned structure, the following effects and advantages can be obtained.

First of all, in the liquid crystal display device 600 of the present exemplary embodiment, the insulating film 26 is selectively provided in the reflective display region R, so that the thickness of the liquid crystal layer 50 in the reflective display region R is about half the thickness of the liquid crystal layer 50 in the transmissive display region T. Therefore, it is possible to make the retardation contributed to reflective display substantially equal to the retardation contributed to transmissive display, thereby enhancing contrast.

Moreover, in general, when a voltage is applied to liquid crystal having negative dielectric anisotropy that is aligned on the vertical alignment film on which a rubbing process has not been performed, the inclined direction of the liquid crystal molecules is not regulated. Thus the liquid crystal molecules are inclined randomly, resulting in an alignment defect. However, in the present exemplary embodiment, in order to regulate the alignment of the liquid crystal molecules, the projections 29a are formed on the lower substrate 10, and the slits 32 are formed in each pixel electrode 31 formed on the inner surface of the upper substrate 25. As a result, the alignment of the liquid crystal molecules are regulated by the incline planes (the island-shaped incline planes) of the projections 29a, and the alignment of the liquid crystal molecules are also regulated by the inclined electric field due to the slits 32. Therefore, it is possible to regulate the alignment directions of the liquid crystal molecules having a vertical alignment in an initial state when a voltage is applied, thereby reducing the likelihood of preventing the generation of disclination due to an alignment defect of liquid crystal molecules. As a result, a residual image generated due to the disclination or color unevenness generated when viewing a display surface of the liquid crystal display device 600 in an inclined direction is barely generated, and thus it is possible to obtain a high-quality display.

Further, in the liquid crystal display device 600 of the present exemplary embodiment, the projections 38 are also formed on the scanning line 13 in fragments. Therefore, it is possible to reduce the likelihood or control or regulate the inclined direction of the liquid crystal molecules in the vicinities of the regions in which the scanning lines 13 are formed. As a result, the alignment disorder (disclination) of liquid crystal molecules is hardly generated not only in the vicinity of the region where the scanning line 13 is formed, but also in all pixel regions, and thus it is possible to prevent the generation of a display defect, such as light leakage, thereby suppressing the generation of display defects, such as a residual image and color unevenness. In addition, it is possible to provide a transflective liquid crystal display device having a wide viewing angle.

Seventh Exemplary Embodiment

Hereinafter, a seventh exemplary embodiment of the present invention will be described with reference to the drawings.

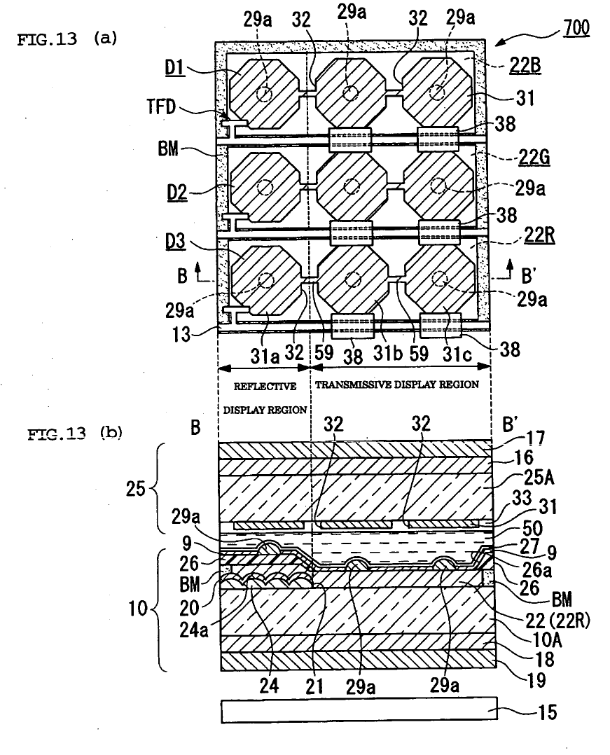

FIGS. 13(a) and 13(b) are schematics illustrating a liquid crystal display device 700 according to the seventh exemplary embodiment, and correspond to FIGS. 12(a) and 12(b) of the sixth exemplary embodiment. The basic structure of the liquid crystal display device according to the sixth exemplary embodiment is the same as that of the sixth exemplary embodiment, but the seventh exemplary embodiment is different from the sixth exemplary embodiment in the structure of the projection 38 formed on the scanning line 13. In FIG. 13, the same components as those in FIG. 12 have the same reference numerals, and a detailed description thereof will be omitted.

As shown in FIG. 13, in the liquid crystal display device 700 according to the seventh exemplary embodiment, the projections 38 are selectively formed on the scanning lines 13 such that they are formed on only the scanning lines 13 in the transmissive display region T, not in the reflective display region R. When the transflective liquid crystal display device according to the present exemplary embodiment has an insulating film 26 to adjust the thicknesses of the liquid crystal layer in the reflective display region R and the transmissive display region T, the thickness of the liquid crystal layer in the reflective display region R is smaller than the thickness of the liquid crystal layer in the transmissive display region T. Then, the electric field between the pixel electrodes 31 and the common electrode 9 is stronger in the reflective display region R than in the transmissive display region T, and the liquid crystal molecules are not much influenced by the horizontal electric field in the reflective display region R. Since the electric field between the pixel electrodes 31 and the common electrode 9 is weaker in the transmissive display region T than in the reflective display region R, the liquid crystal molecules are greatly influenced by the horizontal electric field. Therefore, the present exemplary embodiment makes it possible to prevent or suppress the influence of the horizontal electric field on the liquid crystal molecules in the transmissive display region T by selectively forming the projections 38 in the transmissive display region T.

Eighth Exemplary Embodiment

Hereinafter, an eighth exemplary embodiment of the present invention will be described with reference to the drawings.

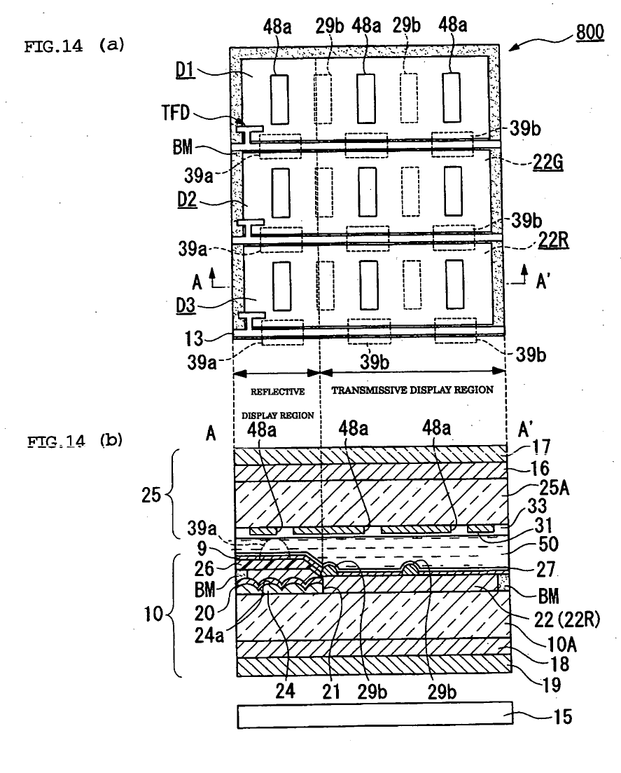

FIGS. 14(a) and 14(b) are schematics illustrating a liquid crystal display device 800 according to the eighth exemplary embodiment, and correspond to FIGS. 12(a) and 12(b) of the sixth exemplary embodiment. The basic structure of the liquid crystal display device according to the eighth exemplary embodiment is the same as that of the sixth exemplary embodiment, but the eighth exemplary embodiment is different from the sixth exemplary embodiment in the structure of the projection formed on the inner surface of the lower substrate 10, the structure of the electrode slit formed in the inner surface of the upper substrate 25, and the structure of the projections formed on the scanning lines 13. In FIG. 14, the same components as those in FIG. 12 have the same reference numerals, and a detailed description thereof will be omitted.

As shown in FIG. 14, in the liquid crystal display device 800 according to the eighth exemplary embodiment, projections 29b are formed on the inner surface of the lower substrate 10 in a longitudinal or rectangular shape in plan view. Slits 48a are formed in each pixel electrode 9, which is formed on the inner surface of the upper substrate 25, in a longitudinal or rectangular shape in plan view. The projections 29b and the slits 48a are arranged at positions different from each other in plan view. That is, the projection 29b is formed so as to be located between adjacent slits 48a in plan view.

On the inner surface of the lower substrate 10, the projections 39a and 39b are formed in fragments at positions overlapping with the scanning lines 13 formed on the upper substrate 25. As such, when the projections 39a and 39b are formed on another substrate opposite to the substrate having the scanning lines 13 thereon, the alignment regulating force generated due to the convex shape of the projection has a stronger influence on the liquid crystal molecules than the horizontal electric field between the scanning lines 13 and the pixel electrodes 31. It is possible to appropriately regulate the alignment of the liquid crystal molecules by the projections having convex shapes.

As shown in FIG. 14(b), in the present exemplary embodiment, the height of the projections 39a formed in the reflective display region R so as to overlap with the scanning lines 13 is equal to the thickness of the liquid crystal layer in the reflective display region R. That is, the projections 39a formed in the reflective display region R are adopted as spacers (photo-spacers) to define the thickness of the liquid crystal layer. In this case, by forming the projections 39a, it is possible to prevent or suppress the generation of the alignment disorder (disclination) of liquid crystal molecules in the vicinities of the scanning lines 13, and to realize a fixed thickness of liquid crystal cells with a simple structure, thereby simplifying a manufacturing process.

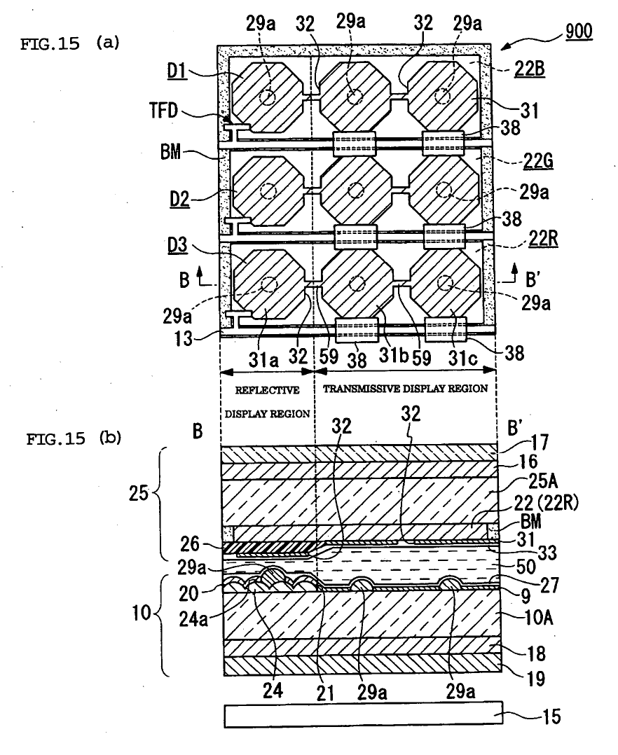

Furthermore, in the transflective liquid crystal display devices shown in FIGS. 12 to 14, the color filter 22 and the insulating film 26 to adjust the thickness of the liquid crystal layer can be formed on the inner surface of the upper substrate 25 as in a liquid crystal display device 900 shown in FIG. 15. The positions where the projections 29a and 29b, the slits 32 and 48a, and the projections 38, 39a, and 39b are formed and the arrangement thereof can be appropriately changed according to the inclined direction of liquid crystal molecules. In the liquid crystal display device 600 shown in FIG. 12, for example, the projections 29a can be formed on the upper substrate 25, and the common electrode 9 having the slits 32 therein can be formed on the lower substrate 10.

Ninth Exemplary Embodiment

Hereinafter, a ninth exemplary embodiment of the present invention will be described with reference to the drawings.

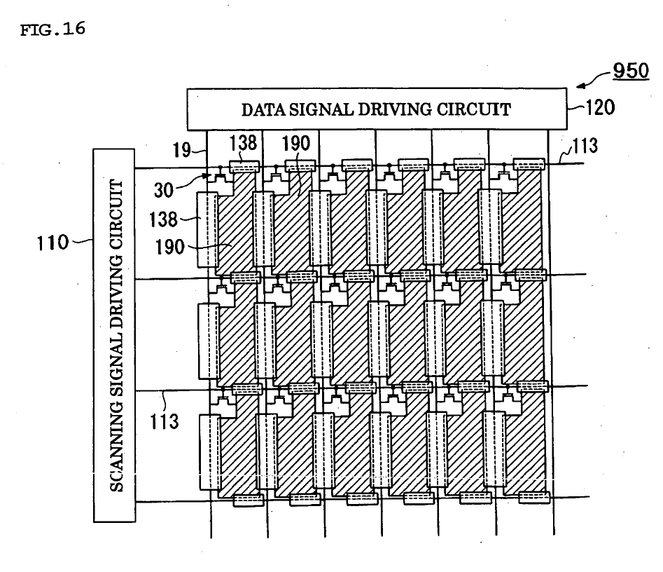

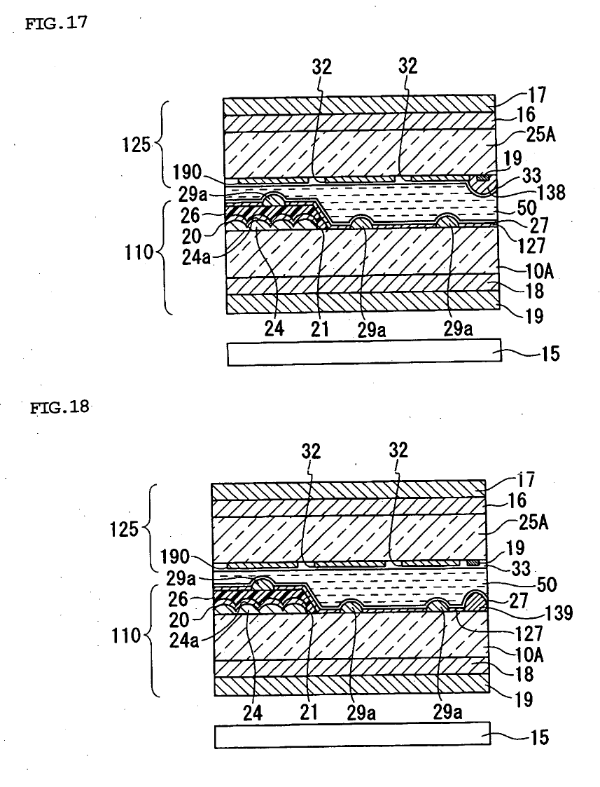

FIG. 16 is a schematic illustrating the circuit structure of a liquid crystal display device 950 according to the ninth exemplary embodiment. The liquid crystal display device 950 according to the ninth exemplary embodiment is an active matrix liquid crystal display device in which TFT elements are used as switching elements. FIG. 17 is a schematic illustrating the cross-sectional structure of the liquid crystal display device 950, and corresponds to FIG. 12 showing the sixth exemplary embodiment. In FIG. 17, the same components as those in FIG. 12 have the same reference numerals, and a detailed description thereof will be omitted.

First, as shown in FIG. 16, a plurality of dots is arranged in the liquid crystal display device 950 of the present exemplary embodiment in a matrix, and a pixel electrode 190 and a TFT 30, which is a switching element to control the pixel electrode 190, are formed in each dot. In addition, sources of the TFTs 30 are electrically connected to data lines 19 through which image signals are supplied. Further, gates of the TFTs 30 are electrically connected to scanning lines 113, and scanning signals are sequentially supplied to a plurality of the scanning lines 113 in the form of a pulse at a predetermined timing. Each pixel electrode 190 is electrically connected to a drain of the TFT 30, and an image signal supplied through the data line 19 is written into the pixel electrode 190 at a predetermined timing by turning on the TFT 30, which is a switching element, at a predetermined period of time.

As such, in the present exemplary embodiment, projections 138 are respectively formed to cover the data lines 19 and scanning lines 113 that are arranged to surround the respective pixel electrodes 190. Specifically, the projection 138 is formed so as to be laid across the pixel electrode 190 and the data line 19, and the projection 138 is also formed to be laid across the pixel electrode 190 and the scanning line 113.

As shown in FIG. 17, the projection 138 is formed to cover the data line 19 formed on the inner surface of an upper substrate 125. In the liquid crystal display device 950 of the present exemplary embodiment, the upper substrate 125 is composed of a TFT array substrate, and the pixel electrodes 190 and the scanning lines 19 are formed on the inner surface of the upper substrate 125. A lower substrate 110 is composed of a counter substrate, and a common electrode 127 is formed on the entire inner surface of the lower substrate 110. Further, alignment films 33 and 27 each having a vertical alignment characteristic are formed on the inner surfaces of the pixel electrodes 190 and the common electrode 127, respectively, similar to the sixth exemplary embodiment.

In the liquid crystal display device 950 of the present exemplary embodiment in which the TFTs 30 are used as switching elements, the projections 29a are formed on the inner surface of the lower substrate 110, and the slits 32 are formed in each pixel electrode 190. Therefore, it is also possible to regulate the inclined direction of the liquid crystal molecules in the dots by an inclined electric field generated due to the convex shapes of the projections 29a and the formation of the slits. Since the projections 138 are formed to cover the scanning lines 19 and the data lines 113, respectively, the pixel electrodes 190 are electrically isolated form the scanning lines 19 and the data lines 113, thereby preventing or suppressing the generation of the horizontal electric field therebetween. As a result, an alignment defect of liquid crystal molecules is hardly generated due to the horizontal electric field, and display defects, such as a residual image and color unevenness, is not generated. Thus, it is possible to provide a transflective liquid crystal display device having a wide viewing angle.

Further, as shown in FIG. 18, the projections 139 to regulate the alignment of liquid crystal molecules in the vicinities of the scanning lines 19 and the data lines 113 may be formed on the lower substrate (the counter substrate) 110. Then, even when the projections 139 are formed on the inner surface of the lower substrate 110 so as to overlap with the scanning lines 19 and the data lines 113 in plan view, it is possible to align the liquid crystal molecules based on the convex shapes by reducing the influence of the horizontal electric field on the liquid crystal molecules between the pixel electrodes 190 and the scanning lines 19 and the data lines 113, by the alignment regulating force generated due to the convex shapes of the projections 139.

Furthermore, as shown in FIGS. 17 and 18, the positions where the projections 138 and 139 are formed and the shapes thereof can be appropriately selected according to the inclined direction of the liquid crystal molecules, and the positions where the projections 29a and the electrode slits 32 in the pixels are formed can also be appropriately selected according to the inclined direction of the liquid crystal molecules. For example, as shown in FIG. 9, by forming the projection 138 so as to cover the scanning line 19 (the data line 113) arranged between adjacent pixel electrodes 190, it is possible to prevent or suppress the generation of the horizontal electric field, and to regulate the alignment of the liquid crystal molecules based on the convex shape of the projection. As shown in FIG. 8, the projection 138 is formed to cover portions of the outer circumferences of the respective pixel electrodes 190 adjacent to each other with the scanning line 19 interposed therebetween, that is, to be laid across the pixel electrodes 190 and the scanning line 19 (the data line 113), and thus it is possible to more effectively reduce the likelihood or prevent the generation of the horizontal electric field.

Moreover, as shown in FIG. 10, even when the projection 139 is formed on the substrate 10A opposite to the substrate 25A having the scanning lines 19 (the data lines 113) thereon so as to overlap with the scanning line 19 (the data line 113) arranged between adjacent pixel electrodes 190 in plan view, the projection 139 may overlap with portions of the outer circumferences of the adjacent pixel electrodes 190 in plan view. In this case, it is possible to further reduce the influence of the horizontal electric field on the liquid crystal molecules between the pixel electrodes 190 and the scanning lines 19 (the data lines 113), by the alignment regulating force generated due to the convex shapes of the projections.

Further, as shown in FIG. 11, the projections may be formed in the vicinities of the scanning lines 19 (the data lines 113), and the projections 138a may be formed between the pixel electrodes 190 and the scanning lines 19 (the data lines 113) without covering the scanning lines 19 (the data lines 113). In addition, when the projections 139a are formed on a substrate opposite to the substrate having the scanning lines 19 (the data lines 113) thereon, the projection 139a is not necessarily overlapped with the scanning line 19 (the data line 113) in plan view. But the projection 139a may be formed opposite to the substrate having the scanning lines 19 (the data lines 113) thereon so as to be located between the pixel electrode 190 and the scanning line 19 (the data line 113) in plan view.

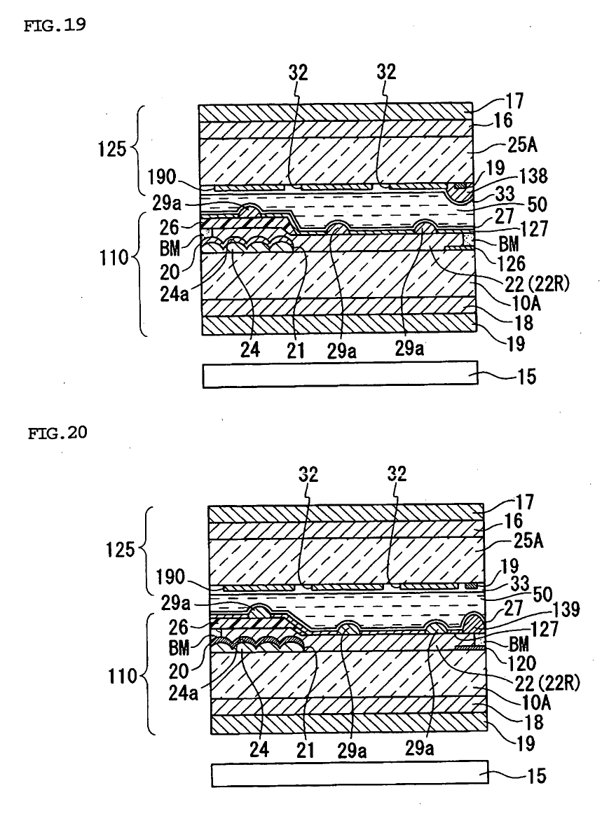

Furthermore, as shown in FIG. 19, when the projection 138 (139) is formed in the transmissive display region T so as to cover the scanning line 19 (the data line 113), a light-shielding film 126 may be formed so as to overlap with the projection 138 (139) in plan view. If the projection 138 (139) is formed as described in the present exemplary embodiment, the liquid crystal molecules are vertically aligned with respect to the incline plane of the projection 138 (139), but are not vertically aligned with respect to the surface of the substrate, resulting in the generation of light leakage. Thus, by forming the light-shielding film 126 so as to overlap with the projection 138 (139) in plan view as shown in FIG. 19, it is possible to prevent or suppress the generation of the light leakage, and thus to provide a liquid crystal display device having excellent display characteristics, such as high contrast and the like.

A metal film made of a light-shielding material, such as chrome or nickel, or a resin black film in which carbon or titanium is dispersed in a photoresist can be used as the light-shielding film 126. The light-shielding film 126 can be formed on the same substrate as the projection 138 (139) is formed on, or on another substrate different from the substrate on which the projection 138 (139) is formed. In addition, it is possible to make the projection 138 (139) function as a light-shielding film by dispersing a light-shielding pigment in the projection 138 (139).

Further, as shown in FIG. 20, when a reflective film 20 is patterned in the reflective display region R, a reflective film 120 is formed in a region overlapping with the projection 138 (139). Therefore, it is possible to shield the region where the projection 138 (139) is formed. In this case, it is possible to prevent or suppress the generation of light leakage in the region where the projection 138 (139) is formed, without increasing the number of manufacturing processes any more.

Furthermore, when the projection 138 (139) also serves as a photo-spacer, it is generally difficult to form the photo-spacer having a smooth surface. In this case, there is a strong possibility of generating light leakage. Therefore, when the projection 138 (139) serves as a photo-spacer, it is possible to more effectively reduce the likelihood or prevent the generation of the light leakage by forming the light-shielding film 126 and the reflective film 120.

Electronic Apparatus

Next, an exemplary embodiment of an electronic apparatus equipped with the liquid crystal display device according to any one of the above-mentioned exemplary embodiments of the present invention will be described.

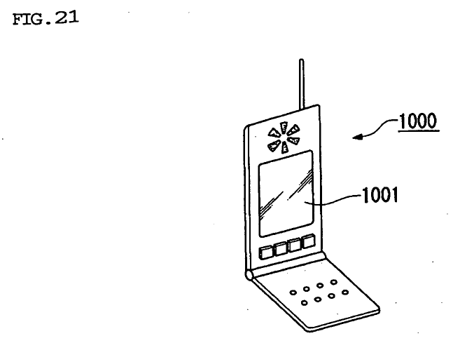

FIG. 21 is a schematic illustrating an example of a mobile phone. In FIG. 21, reference numeral 1000 indicates a main body of the mobile phone, and reference numeral ‘1001’ indicates a display unit using the above-mentioned liquid crystal display device. When the liquid crystal display device according to any one of the above-mentioned exemplary embodiments is used for the display unit of an electronic apparatus, such as a mobile phone, it is possible to achieve an electronic apparatus equipped with a liquid crystal display unit capable of displaying a bring and high-contrast image in a wide viewing angle range, regardless of its usage environment.

Furthermore, the present invention is not limited to the above-mentioned exemplary embodiments, and can be appropriately modified within the scope of the present invention. For example, in any one of a reflective liquid crystal display device, a transmissive liquid crystal display device, and a transflective liquid crystal display device, TFDs or TFTs can be used as switching elements, and it is also possible to select any one of the above-mentioned exemplary embodiments by a combination of the projections and the slits.

1. A liquid crystal display device, in which display is performed in predetermined pixel units, comprising:
a pair of substrates;
a liquid crystal layer interposed between the pair of substrates, the liquid crystal layer being composed of liquid crystal having negative dielectric anisotropy that is vertically aligned in an initial state, and signal lines through which signals are supplied to the pixels are formed on an inner surface of at least one of the pair of substrates; and
convex portions made of a dielectric material being formed around and/or on the signal lines on the inner surface of at least one of the pair of substrates.

2. A liquid crystal display device, in which display is performed in predetermined pixel units, comprising:
a pair of substrates;
a liquid crystal layer is interposed between the pair of substrates, the liquid crystal layer being composed of liquid crystal having negative dielectric anisotropy that is vertically aligned in an initial state, and signal lines through which signals are supplied to the pixels are formed on an inner surface of at least one of the pair of substrates; and
convex portions made of a dielectric material being formed on the inner surface of the at least one of the pair of substrates so as to cover at least the signal lines in plan view.

3. The liquid crystal display device according to claim 1,
each of the convex portions having a longitudinal shape and extending along each of the signal lines.

4. The liquid crystal display device according to claim 1,
each of the convex portions having a dot shape and extending along each of the signal lines.

5. The liquid crystal display device according to claim 1,
pixel electrodes being formed on the inner surface of the substrate on which the signal lines are formed, and at least a portion of each convex portion being formed between the pixel electrodes and the signal lines.

6. The liquid crystal display device according to claim 1,
the pixel electrodes being formed on the inner surface of the substrate on which the signal lines are formed, and each convex portion being formed so as to be laid across the pixel electrodes and the signal lines in plan view.

7. The liquid crystal display device according to claim 1,
the pixel electrodes being formed on the inner surface of the substrate on which the signal lines are formed, and each convex portion being formed so as to be laid across the edge of the pixel electrodes and the signal lines in plan view.

8. The liquid crystal display device according to claim 1,
the pixel electrodes being formed on the inner surface of the substrate on which the signal lines are formed, and each convex portion being formed so as to cover a portion of both the pixel electrodes and the signal lines.

9. The liquid crystal display device according to claim 1,
the pixel electrodes being formed on the inner surface of the substrate on which the signal lines are formed, and each convex portion being formed at positions where the pixel electrodes are closest to the signal lines.

10. The liquid crystal display device according to claim 1,
the convex portions being formed on the substrate on which the signal lines are formed.

11. The liquid crystal display device according to claim 1,
the convex portions being formed on the other substrate, other than the substrate on which the signal lines are formed.

12. The liquid crystal display device according to claim 1,
a light-shielding film being formed so as to overlap with the convex portions in plan view.

13. The liquid crystal display device according to claim 1,
a plurality of the convex portions being formed in each of the pixels.

14. The liquid crystal display device according to claim 1,
spacers to define the gap between the pair of substrates being formed on the inner surface of the at least one of the pair of substrates, and the convex portions are made of the same material as the spacers.

15. The liquid crystal display device according to claim 1,
each convex portion being a structure to regulate the direction in which the vertically aligned liquid crystal molecules are inclined according to a change of an electric field.

16. The liquid crystal display device according to claim 1,
the pair of substrates being an upper substrate and a lower substrate, and a backlight being formed on a surface of the lower substrate opposite to the liquid crystal layer to display an image on an outer surface of the upper substrate.

17. The liquid crystal display device according to claim 1,
the pair of substrates being an upper substrate and a lower substrate, and a reflective film being formed on a surface of the lower substrate facing the liquid crystal layer to display an image on the outer surface of the upper substrate.

18. The liquid crystal display device according to claim 1,
the pair of substrates being an upper substrate and a lower substrate,
a backlight being formed on a surface of the lower substrate opposite to the liquid crystal layer, and a reflective film being selectively provided in only a predetermined region on the other surface of the lower substrate facing the liquid crystal layer, and
the region in which the reflective film being formed is a reflective display region, and a region in which the reflective film is not formed is a transmissive display region.

19. The liquid crystal display device according to claim 1,
a layer to adjust the thickness of the liquid crystal layer being formed in at least the reflective display region between the liquid crystal layer and the at least one of the pair of substrates such that the thickness of the liquid crystal layer in the reflective display region is different from the thickness of the liquid crystal layer in the transmissive display region.

20. The liquid crystal display device according to claim 19,
the convex portions being selectively formed in the transmissive display region.

21. The liquid crystal display device according to claim 17,
the convex portions being selectively formed in the region in which the reflective layer is formed, and the convex portions define the gap between the pair of substrates.

22. An electronic apparatus, comprising:
the liquid crystal display device according to claim 1.
